(19) United States
(12) Patent Application Publication
(10) Pub. No.: US 2013/0064553 A1
(43) Pub. Date: Mar. 14, 2013

(54) OPTICAL COMMUNICATION MODULE AND OPTICAL COMMUNICATION APPARATUS

(71) Applicant: Koji NAKAHARA, Yamato (JP)

(72) Inventor: Koji NAKAHARA, Yamato (JP)

(73) Assignee: FUJITSU LIMITED, Kawasaki-shi (JP)

(21) Appl. No.: 13/610,795

(22) Filed: Sep. 11, 2012

(30) Foreign Application Priority Data
Sep. 13, 2011 (JP) 2011-199779

(51) Int. Cl. H04B 10/14

(52) U.S. Cl. 398/139

(57) ABSTRACT

An optical communication module comprising: a light emitting element to emit light; a light transmission medium to receive incidence of the light from the light emitting element; a diverging unit to be provided on the light transmission medium and to diverge some proportion of the light emitted from the light emitting element to the light transmission medium and propagating within the light transmission medium; and a first light receiving element to receive the light from the light emitting element, which is diverged by the diverging unit.

### CROSS-REFERENCE TO RELATED APPLICATION

This application is based upon and claims the benefit of priority of the prior Japanese Patent Application No. 2011-199779 filed on Sep. 13, 2011, the entire contents of which are incorporated herein by reference.

### FIELD

The present invention relates to an optical communication module and an optical communication device.

### BACKGROUND

In recent years, an optical communication module has been used in a variety of environments irrespective of whether indoor or outdoor. The optical communication module is requested to stabilize and thus output an optical signal. The output of the optical signal of the optical communication module is easy to be affected by usage environments such as variations in temperature and vibrations. It is therefore required to restrain fluctuations in optical output level of the optical communication module.

FIG. 1 is a view illustrating an example (1) of a conventional optical communication module. FIG. 1 depicts an example of a sectional structure parallel to an optical axis of an optical communication module 2100. The optical communication module 2100 in FIG. 1 is exemplified as a configuration of a transmission side. The optical communication module 2100 in FIG. 1 includes an LD-CHIP (Laser Diode Chip) 2102, a lens 2104, a ferrule 2106, an optical fiber 2108 and an M-PD (Monitor Photo Diode) 2110. The optical fiber 2108 is held by a housing via the ferrule 2106. Herein, light beams emitted from the LD-CHIP 2102 toward the lens 2104 are called front light (the light beams on a front side), while the light beams emitted from the LD-CHIP 2102 toward the M-PD 2110 are called back light (the light beams on a back side). In FIG. 1, the front side represents a side on which the lens 2104, the optical fiber 2108, etc exist in front of the LD-CHIP 2102. In FIG. 1, the back side represents a side on which the M-PD 2110 exists in rear of the LD-CHIP 2102. The front light emitted from the LD-CHIP 2102 toward the lens 2104 is output from the optical communication module 2100 via the lens 2104, the optical fiber 2108, etc. The light beams, which are output from the optical communication module 2100, are received by an apparatus on the reception side.

The LD-CHIP 2102 is a light emitting element. Light beams (front light) emitted from the LD-CHIP 2102 are condensed (converged) by the lens 2104 and are optically coupled (opto-coupled) by the optical fiber 2108 in the ferrule 2106. The light beams, which are opto-coupled by the optical fiber 2108, are output through the optical fiber 2108.

Further, the M-PD 2110 is a light receiving element. The M-PD 2110 monitors the back light of the LD-CHIP 2102. An optical output level of the LD-CHIP 2102 is controlled so as to keep a fixed level of optical output by an APC (Auto Power Control) circuit on the basis of an intensity of the back light received by the M-PD 2110. The APC based on the back light is capable of restraining fluctuations in optical output of the LD-CHIP 2102 itself.

FIG. 2 is a view depicting an example (2) of the conventional optical communication module. FIG. 2 illustrates an example of a sectional structure parallel to the optical axis of an optical communication module 2200. The optical communication module 2200 in FIG. 2 is exemplified by way of the configuration of the transmission side and a configuration on the reception side. The optical communication module 2200 includes an LD-CHIP 2202, a first lens 2204, a ferrule 2206, an optical fiber 2208, an M-PD 2210, a first filter 2212, a second filter 2222, a second lens 2224 and a PD (Photo Diode) 2226.

The light beams (front light) emitted from the LD-CHIP 2202 is, similarly to the example in FIG. 1, output via the optical fiber. Further, an optical output level of the LD-CHIP 2202 is, similarly to the example in FIG. 1, controlled so as to keep a fixed level of optical output by the APC circuit on the basis of an intensity of the back light received by the M-PD 2210.

Moreover, the light beams inputted from the outside through the optical fiber 2208 are reflected by the first filter 2212. The second filter 2222 selects a light beam having a predetermined wavelength from the reflected light beams. Further, the light beams passing through the second filter 2222 are converged by the second lens 2224 and received by the PD 2226.

### DOCUMENTS OF PRIOR ARTS

### Patent Document

[Patent document 1] Japanese Patent Application Laid-Open Publication No. 2010-239079
[Patent document 2] Japanese Patent Application Laid-Open Publication No. 2004-294513
[Patent document 3] Japanese Patent Application Laid-Open Publication No. 2002-252418

### SUMMARY

An optical system on the front side of an LD-CHIP 2102 of an optical communication module 2100 might cause optical fluctuations etc due to a tracking error and an external stress (vibration, impact, etc), in which optical coupling characteristics vary due to a change in temperature of a ferrule 2106 etc. The front-sided optical fluctuations etc of the LD-CHIP 2102 affect the light beams output from the optical communication module 2100 but hardly affect the light beams on the back side. Further, an optical output level of the front-sided light beams of the LD-CHIP 2102 does not depend on an optical output level of the back-sided light beams of the LD-CHIP 2102 in some cases according to characteristics, a malfunction, etc of the LD-CHIP 2102. Hence, an intensity of the light beams output from the optical communication module 2100 does not depend on an intensity of the back-sided light beams of the LD-CHIP 2102 as the case may be. Accordingly, the optical communication module 2100 is unable to stabilize an optical output level even by conducting APC control in a way that uses the back-sided light beams of the LD-CHIP 2102 in some cases. This is the same with the optical communication module 2200. What affects the light beams on the front side is exemplified such as thermal expansions, thermal contractions, vibrations and impacts of the respective components, the vibrations of the lenses and the vibrations of the fibers.

One aspect of the disclosure is an optical communication module including: a light emitting element to emit light; a light transmission medium to receive incidence of the light from the light emitting element; a diverging unit to be provided on the light transmission medium and to diverge some proportion of the light emitted from the light emitting element to the light transmission medium and propagating within the light transmission medium; and a first light receiving element to receive the light from the light emitting element, which is diverged by the diverging unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 is a view illustrating an example (1) of a conventional optical communication module.

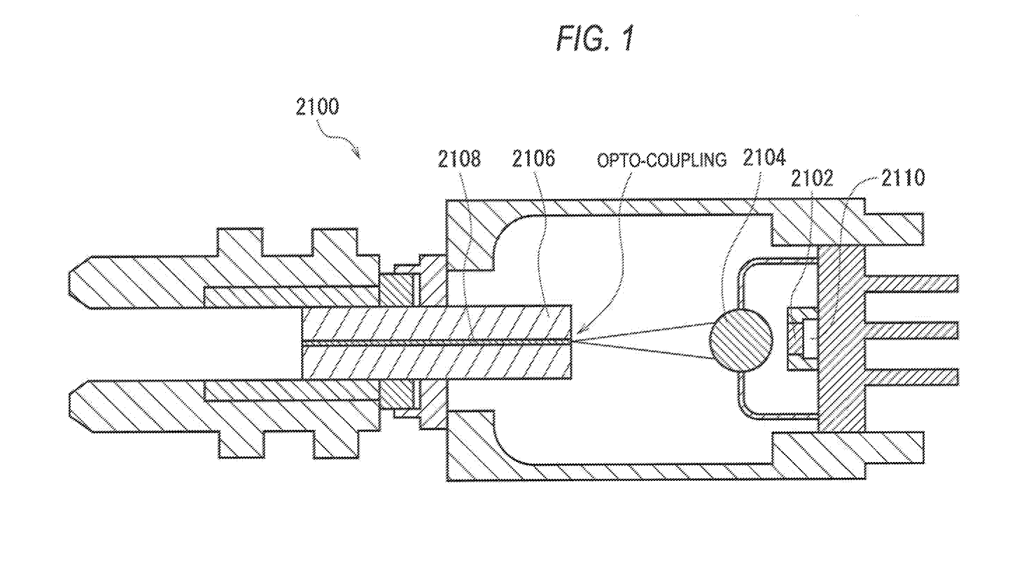

FIG. 2 is a view illustrating an example (2) of the conventional optical communication module.

FIG. 3 is a view illustrating an example of a sectional structure parallel to an optical axis of an optical communication module (1).

FIG. 4 is a view depicting an example of a wavelength demultiplexing multi-layered flat glass.

FIG. 5 is a diagram illustrating an example of characteristics of a filter.

FIGS. 6A, 6B and 6C are a view illustrating an example (1-1) of how a ferrule is assembled.

FIGS. 7A, 7B and 7C are a view illustrating an example (1-2) of how the ferrule is assembled.

FIGS. 8A, 8B and 8C are a view illustrating an example (1-3) of how the ferrule is assembled.

FIGS. 9A, 9B and 9C are a view illustrating an example (1-4) of how the ferrule is assembled.

FIG. 10 is a diagram illustrating examples of an LD-CHIP, M-PD and an APC circuit.

FIG. 11 is a view illustrating an example of the sectional structure parallel to the optical axis of an optical communication module (2).

FIG. 12 is a view illustrating an example (1) of a light shielding structure of a transparent ferrule.

FIG. 13 is a view illustrating an example (2) of the light shielding structure of the transparent ferrule.

FIG. 14 is a view illustrating an example (3) of the light shielding structure of the transparent ferrule.

FIG. 15 is a view illustrating an example of the sectional structure parallel to the optical axis of an optical communication module (3).

FIG. 16 is a view illustrating an example of the sectional structure parallel to the optical axis of an optical communication module (4).

FIGS. 17A, 17B and 17C are a view illustrating an example (2-1) of how the ferrule is assembled.

FIGS. 18A, 18B and 18C are a view illustrating an example (2-2) of how the ferrule is assembled.

FIGS. 19A, 19B and 19C are a view illustrating an example (2-3) of how the ferrule is assembled.

FIGS. 20A, 20B and 20C are a view illustrating an example (2-4) of how the ferrule is assembled.

FIGS. 21A, 21B and 21C are a view illustrating an example (2-5) of how the ferrule is assembled.

FIG. 22 is a view illustrating an example of the sectional structure parallel to the optical axis of an optical communication module (5).

FIG. 23 is a view illustrating an example of the sectional structure parallel to the optical axis of an optical communication module (6).

FIG. 24 is a view illustrating an example of the sectional structure parallel to the optical axis of an optical communication module (7).

FIG. 25 is a view illustrating an example of the sectional structure parallel to the optical axis of an optical communication module (8).

FIG. 26 is a view illustrating an example of a configuration of an optical communication device.

### DESCRIPTION OF EMBODIMENTS

Embodiments will hereinafter be described with reference to the drawings. Configurations in the embodiments are exemplifications, and a construction of the disclosure is not limited to the concrete configurations in the embodiments of the disclosure. Implementation of the construction of the disclosure may involve properly adopting the concrete configurations corresponding to the embodiments.

### First Embodiment

In an optical communication module of a first embodiment, part of light beams entering an optical fiber on the front side of an LD-CHIP are reflected by a filter installed within the optical fiber and received by an M-PD. The optical communication module controls an output of the LD-CHIP on the basis of an intensity of the light beams received by the M-PD. The optical communication module, which is incorporated into, e.g., an optical communication apparatus, converts an electric signal into an optical signal and transmits the optical signal. Further, the optical communication module is connected to a light transmission path (an optical fiber etc) through another ferrule etc and is thus enabled to transmit the optical signal to another apparatus on the reception side.

(Example of Configuration)

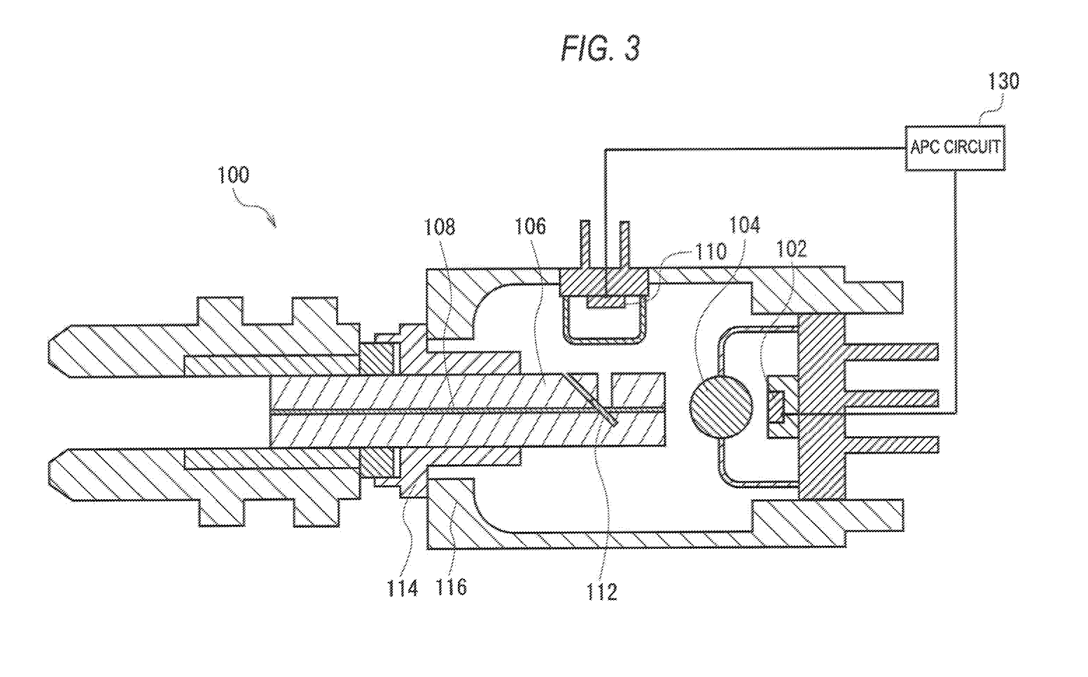

FIG. 3 is a view illustrating an example of a sectional structure parallel to an optical axis of the optical communication module. An optical communication module 100 transmits the optical signal. The optical communication module 100 in FIG. 3 includes an LD-CHIP (Laser Diode Chip) 102, a lens 104, a ferrule 106, an optical fiber 108, an M-PD (Monitor Photo Diode) 110, a filter 112 and an APC (Automatic Power Control) circuit 130. The optical fiber 108 is held within a housing 116 of the optical communication module 100 through the ferrule 106 and a sleeve 114.

The LD-CHIP 102 is a light emitting element. The LD-CHIP 102 emits light beams having an intensity which depends on a current value of an inputted electric current. The APC circuit 130 controls the current value of the electric current inputted to the LD-CHIP 102. The APC circuit 130 can operate as a control unit. Herein, the LD-CHIP is used as the light emitting element, however, other types of light emitting elements may also be utilized. A wavelength of the light beams emitted from the LD-CHIP 102 is, e.g., 1310 nm. The LD-CHIP 102 outputs the optical signal having the intensity based on the inputted electric signal.

The lens 104 converges the light beams coming from the LD-CHIP 102 at an end portion of the optical fiber 108 and gets the light beams to be opto-coupled thereat. The lens 104 is exemplified such as a spherical lens, an aspherical lens and a ball lens. The lens 104 is not, however, limited to these types of lenses. The optical axis of the lens 104 is disposed coaxially with a central axis of, e.g., the optical fiber 108.

The ferrule 106 fixes the optical fiber 108 within the optical communication module 100. A material exhibiting a small expansion coefficient is used for the ferrule 106. Usable materials for the ferrule 106 are opaque materials such as zirconia ceramics, resins and metals. The ferrule 106 takes a cylindrical shape that is, e.g., 2.5 mm in diameter and 10 mm in length. The material and the shape of the ferrule 106 are not limited to those given above. The ferrule 106 is connected to another ferrule etc in a way that comes into contact therewith, whereby the optical fiber 108 within the ferrule 106 can be connected to the light transmission path (optical fiber etc).

A hole, which penetrates a central portion of a circle of the cylinder, is bored in the ferrule 106, thereby letting the optical fiber 108 therethrough. Further, the filter 112 is embedded in the ferrule 106. The filter 112 is embedded so as to cut off the optical fiber 108. Moreover, the ferrule 106 has a hole bored for taking out the light beams reflected by the filter 112. The hole for taking out the light beams reflected by the filter 112 is, e.g., 1.0 mm in diameter.

The ferrule 106 is press-fitted in the sleeve 114. The sleeve 114 undergoing the press-fitting of the ferrule 106 is fixed within the housing 116. The sleeve 114 and the housing 116 can be welded together by use of YAG (Yttrium Aluminum Garnet) and thus fixed.

The optical fiber 108 is a light transmission medium. The optical fiber 108 propagates the light beams, which are opto-coupled at the end portion on the side of the LD-CHIP 102 and get incident thereon, toward the other end portion thereof. The optical fiber 108 is fixed by the ferrule 106. The optical fiber 108 is 0.125 mm in diameter. Usable fibers as the optical fiber are a single-mode fiber (SMF) and a multi-mode fiber (MMF). Herein, the optical fiber is used as the light transmission medium, however, light transmission mediums other than the optical fibers may also be employed.

The M-PD 110 is a light receiving element for a monitor. The M-PD 110 receives mainly the light beams emitted from the LD-CHIP 102 and reflected by the filter 112. The M-PD 110 converts the received light beams into the electric signals (electric current) depending on the intensity of the received light beams. The M-PD 110 is connected to the APC circuit 130. Herein, the PD (Photo Diode) is used as the light receiving element for the monitor, however, other types of light receiving elements may also be employed in place of the PD. A lens for the converging the light beams may also be provided in front of the M-PD 110.

The filter 112 reflects part of the light beams entering the optical fiber 108. The filter 112 is inserted so as to cut off the optical fiber 108. Accordingly, the filter 112 diverges part of optical signals outgoing from the LD-CHIP 102 and transmitted on the reception side through the optical fiber 108. A size of the filter 112 is larger than the section of the optical fiber 108 to be cut off. The filter 112 is approximately, e.g., 0.1 mm to 0.5 mm in thickness. The filter 112 is one example of a diverging unit.

The filter 112 transmits a large proportion of light beams in a predetermined wavelength range but reflects part of the light beams in the predetermined wavelength range. The filter 112 involves using, e.g., a wavelength demultiplexing multi-layered flat glass. The filter 112 is not limited to the wavelength demultiplexing multi-layered flat glass.

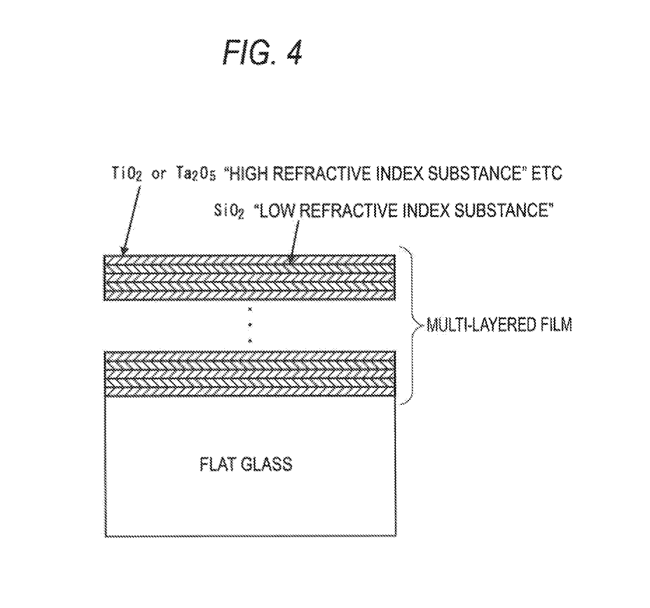

FIG. 4 is a view depicting an example of the wavelength demultiplexing multi-layered flat glass. The wavelength demultiplexing multi-layered flat glass includes a multi-layered film composed of SiO₂ (a material having a low refractive index) and TiO₂ or Ta₂O₅ (a material having a high refractive index) and a flat glass.

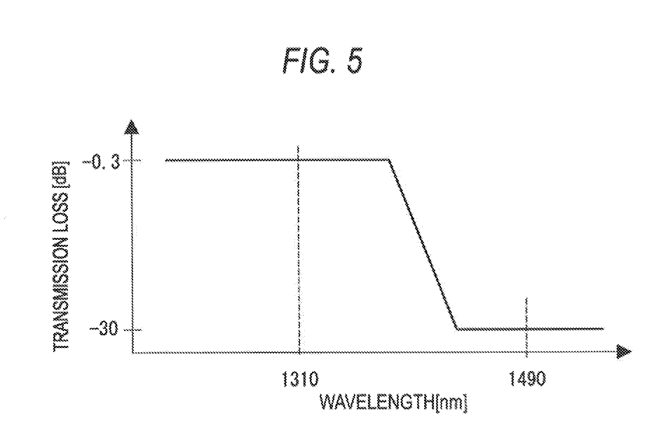

FIG. 5 is a graphic chart illustrating an example of characteristics of the filter. In the graph of FIG. 5, the axis of abscissas represents a wavelength of the light, and the axis of ordinates represents a transmission loss. The filter having the characteristics indicated by the graph of FIG. 5 transmits the large proportion of light beams in the vicinity of a wavelength of 1310 nm but reflects the large proportion of light beams in the vicinity of a wavelength of 1490 nm. Further, the filter having the characteristics indicated by the graph of FIG. 5 reflects the light beams in the vicinity of the wavelength of 1310 nm at a predetermined rate. In the example of FIG. 5, the intensity of the transmitted light beams decreases by 0.3 dB at 1310 nm and decreases by 30 dB at 1490 nm.

Herein, an assumption is that the filter having the characteristics indicated by the graph of FIG. 5 is used as the filter 112. A further assumption is that the wavelength of the light beams output from the LD-CHIP 102 is 1310 nm. At this time, the large proportion of light beams entering the optical fiber 108 from the LD-CHIP 102 pass through the filter 112, while part of the light beams are reflected by the filter 112 and get incident on the M-PD 110.

An angle made by a reflection surface of the filter 112 or a vertical hole bored in the ferrule 106 in order for the M-PD 110 to receive the light beams and by the central axis of the ferrule 106 may be whatever angle if enabling the M-PD 110 to receive stably the light beams coming from the optical fiber.

(Example of Assembling Ferrule)

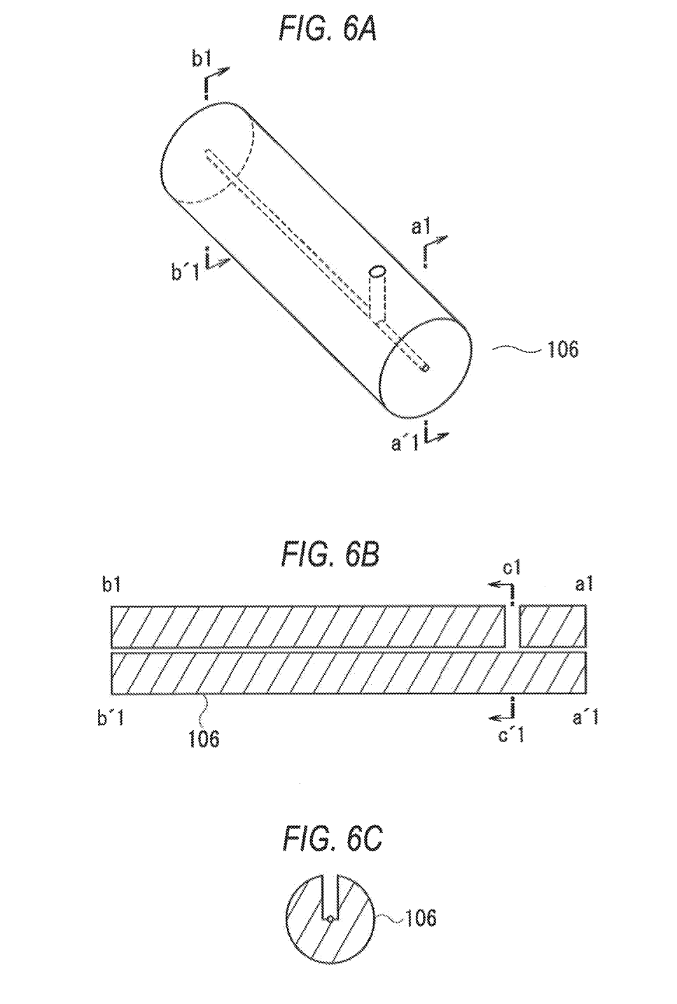

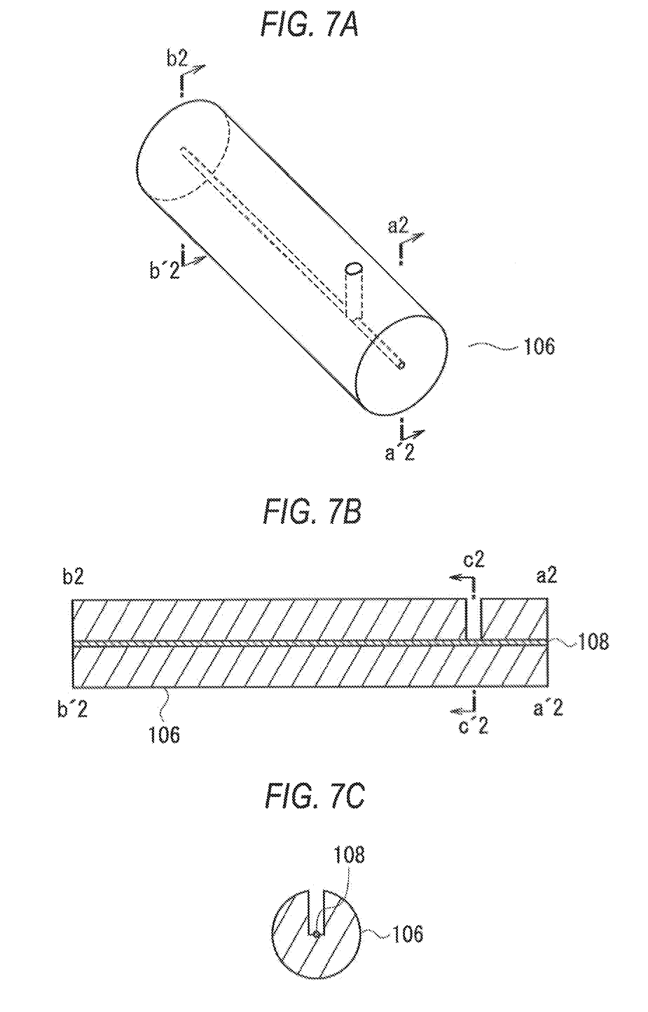

FIGS. 6A through 9C are views illustrating how the ferrule 106 is assembled. The optical fiber 108 and the filter 112 are built in the ferrule 106. FIG. 6A is a perspective view of the ferrule 106 etc. The near side of the ferrule 106 in FIG. 6A is the side of the end face on which the light beams coming from the LD-CHIP 102 get incident. FIG. 6B is a sectional view of the ferrule 106 etc on the plane embracing a line segment a1-a′1 and a line segment b1-b′1 in FIG. 6A. FIG. 6C depicts a section of the ferrule 106 etc on the plane embracing a line segment c1-c′1 in FIG. 6B and being orthogonal to the section in FIG. 6B. The same view configuration is applied to other similar views (FIGS. 7A, 7B and 7C, etc.).

As in FIG. 6A, the ferrule material such as the zirconia ceramics is formed in the cylindrical shape. One of the flat circular surfaces of the cylinder is defined as a lower surface, while the other is defined as an upper surface. The right side in FIG. 6B is defined as a lower surface side, while the left side is defined as an upper surface side. The upper surface side of the ferrule 106 is installed on the side of the LD-CHIP 102 in the optical communication module 100. Furthermore, a curved surface of the cylinder is defined as a side surface. A straight line, which embraces a line segment extending from the center of the lower surface up to the center of the upper surface, is defined as the central axis.

As in FIGS. 6A, 6B and 6C, a hole (a through-hole, a horizontal hole), through which the optical fiber is allowed to pass, is bored into the central axis of the cylinder. The hole takes a cylindrical shape, and the center of the hole is coincident with the central axis. If the optical fiber to be used is 125 μm in diameter, the diameter of the hole is set equal to or slightly larger than 125 μm. For example, the diameter of the hole is 125.5 μm. If the section of the optical fiber is not circular, the horizontal hole taking a shape matching with the section of the optical fiber may also be bored.

Moreover, as in FIGS. 6A, 6B and 6C, the vertical hole is bored till reaching the hole for letting through the optical fiber from the side surface of the ferrule 106. Namely, the hole is bored from the side surface of the optical fiber 108 down to the central axis. Some proportion of the light beams entering the optical fiber 108 are taken out of the thus-bored vertical hole. An angle made by the bored vertical hole and the central axis is, e.g., 90 degrees. The vertical hole may take the cylindrical shape and may also take a conical shape with its vertex formed in the vicinity of the central axis.

Next, as in FIGS. 7A, 7B and 7C, the optical fiber 108 is inserted into the through-hole (the horizontal hole) filled with a bonding agent. Further, the optical fiber 108 coated with the bonding agent may also be inserted into the through-hole. The optical fiber 108 is fixed to the ferrule 106 upon hardening the bonding agent. The optical fiber 108 is inserted from the lower surface of the ferrule 106 up to the upper surface. The end faces (the upper and lower surfaces) of the ferrule 106 and the optical fiber 108 are polished. The (surface of) optical fiber 108 is polished, thereby facilitating the entrance of the light beams into the optical fiber 108.

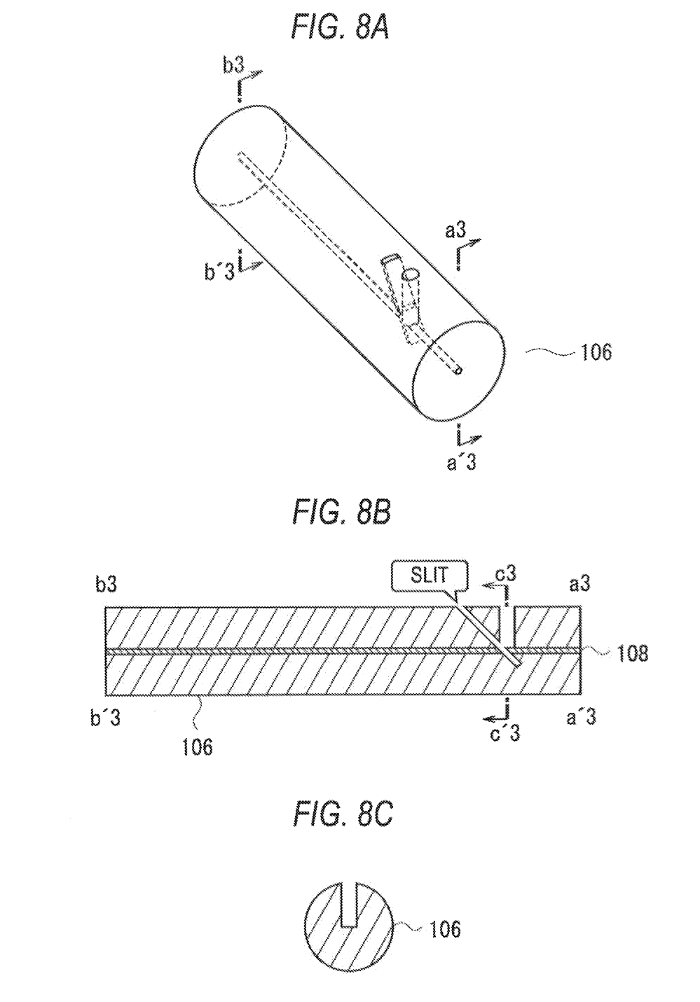

Next, as in FIGS. 8A, 8B and 8C, a slit, into which to insert the filter 112, is cut open from the side surface of the ferrule 106. An angle made by the slit and the central axis is, e.g., 45 degrees. The slit is formed corresponding to a size of the filter 112. The slit is cut open toward a connecting portion (intersection) between the central axis and the vertical hole. The slit receiving the insertion of the filter 112 is worked by, e.g., a dicing technique. At this time, the optical fiber is cut off.

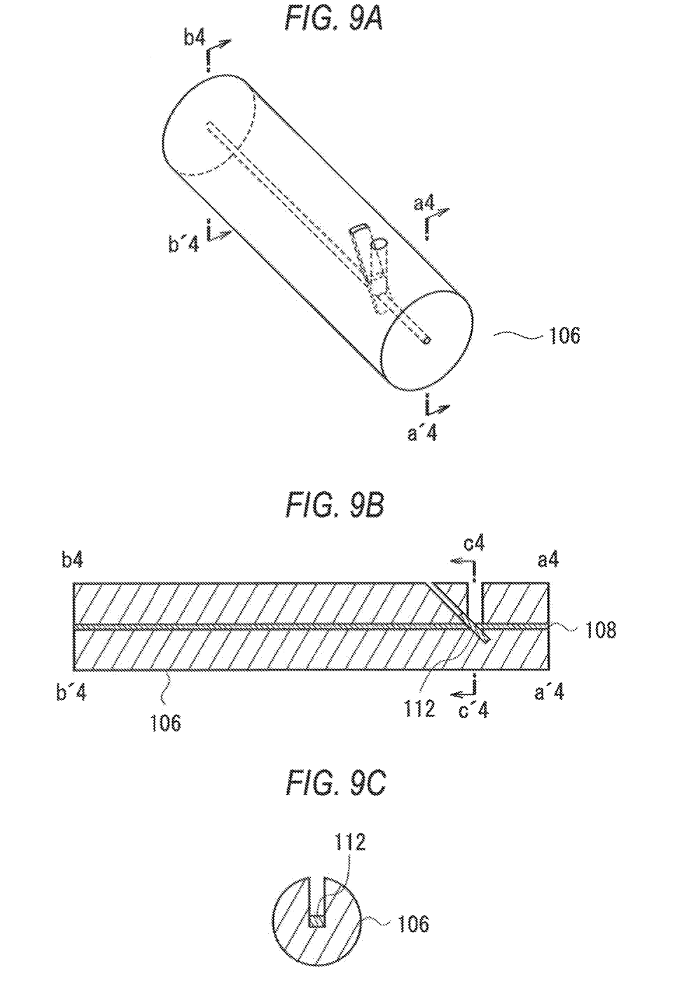

Next, as in FIGS. 9A, 9B and 9C, the filter 112 is inserted into the slit. The filter 112 is hardened by, e.g., the bonding agent. As the sizes of the filter 112 and the slit become smaller, a friction resistance between the filter 112 and the ferrule 106 gets smaller, thereby facilitating the insertion of the filter 112.

The vertical hole may be filled with a transparent resin. At this time, it is preferable that a resin having the same refractive index as the refractive index of a cladding portion of the optical fiber is used as the transparent resin. Further, on the occasion of hardening the optical fiber, the transparent bonding agent is used to fill the vertical hole, whereby the optical fiber may be thus hardened simultaneously with fixing this optical fiber.

(APC Circuit)

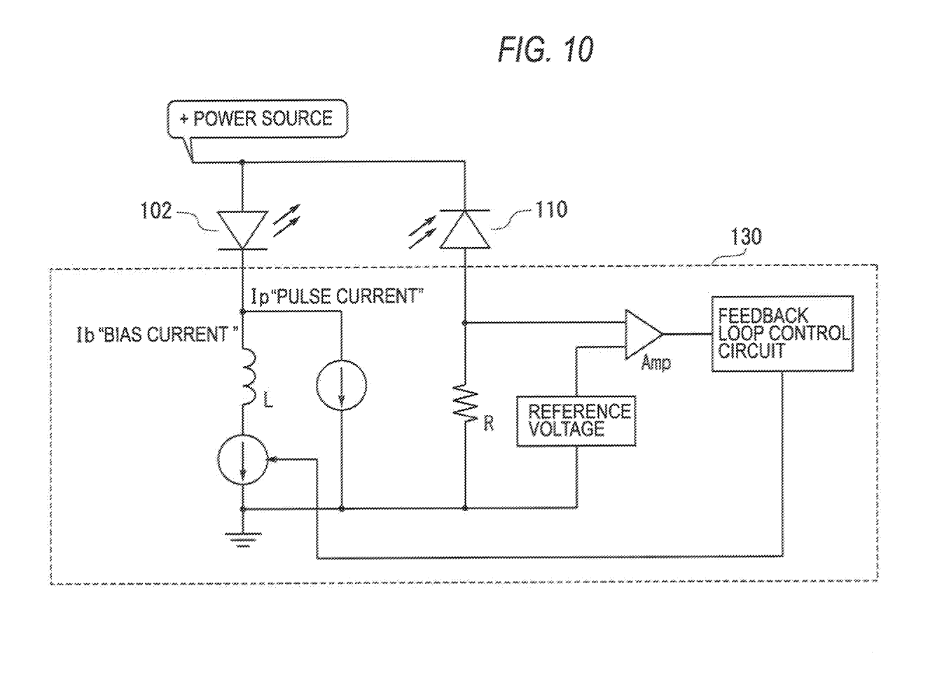

FIG. 10 is a diagram illustrating examples of the LD-CHIP, the M-PD and the APC circuit. The APC circuit 130 is not limited to the example in FIG. 10. The LD-CHIP 102 and the M-PD 110 are connected to the APC circuit 130. The APC circuit 130 can be realized by hardware such as an Application Specific Integrated Circuit (ASIC) etc.

The APC circuit 130 controls the electric power applied to the LD-CHIP 102 on the basis of the intensity of the light beams received by the M-PD 110. The APC circuit 130 controls the electric power applied to the LD-CHIP 102 so that the intensity of the light beams received by the M-PD 110 is kept fixed.

A backward bias is applied to the M-PD 110. When the light beams enter the M-PD 110, the electric current flows. That is, when the M-PD 110 receives the light beams reflected from the filter 112, the light beams are converted into the electric signals (current). The electric signals converted by the M-PD 110 are amplified by a reference voltage and by an amplifier (Amp) and are inputted to a feedback loop control circuit. The setup of the reference voltage of the APC circuit and the configuration of the amplifier in FIG. 10 are not limited to those in FIG. 10, and whatever setup and configuration are available if the electric signals converted by the M-PD 110, i.e., the voltages at the both of terminals of a resistance R are amplified. Further, the electric signals converted by the M-PD 110 may also be amplified within the feedback loop control circuit. The electric current may be converted into the voltage.

The feedback loop control circuit controls a bias current of the LD-CHIP 102 so that a magnitude of the inputted signal, i.e., the intensity of the light beams received by the M-PD 110 reaches the target value. The feedback loop control circuit compares the magnitude of the inputted signal with a predetermined reference value (the target value) of the signal, thus adjusting the bias current of the LD-CHIP 102.

For example, the feedback loop control circuit, if the intensity of the light beams received by the M-PD 110 is one-half of the reference value of the intensity of the light beams, adjusts the bias current so that the electric current supplied to the LD-CHIP 102 is doubled. This leads to such anticipation that the intensity of the light beams emitted from the LD-CHIP 102 is doubled, and the intensity of the light beams received by the M-PD 110 becomes equal to the reference value.

(Operation, Effect of First Embodiment)

The optical communication module 100 emits the light beams (the optical signals) from the LD-CHIP 102. The light beams emitted from the LD-CHIP 102 are opto-coupled at the end portion of the optical fiber 108 in the ferrule 106 via the lens 104. The opto-coupled light beams travel through within the optical fiber 108 and penetrate the filter 112. The light beams penetrating the filter 112 are output from the optical communication module 100. Moreover, some proportion of the opto-coupled light beams are reflected by the filter 112 and received by the M-PD 110. The M-PD 110 receives the light beams emitted from the LD-CHIP 102, entering the optical fiber and reflected by the filter 112. Hence, the intensity of the light beams output from the optical communication module 100 depends on the intensity of the light beams received by the M-PD 110. The light beams received by the M-PD 110 are converted into the electric signals depending on the intensity of the light beams. The APC circuit 130 controls the current value of the electric current supplied to the LD-CHIP 102, corresponding to the intensity of the light beams received by the M-PD 110. The APC circuit 130 controls the intensity of the light beams emitted from the LD-CHIP 102 so that the intensity of the light beams received by the M-PD 110 gets fixed. The optical communication module 100 can adjust the intensity of the light beams emitted from the LD-CHIP 102 on the basis of the intensity of the light beams which travel through the optical fiber 108 after being opto-coupled.

The filter 112 reflects the light beams at a predetermined ratio, and consequently the intensity of the light beams received by the M-PD 110 gets fixed, thereby stabilizing the intensity of the light beams output from the optical communication module 100.

The optical communication module 100 controls the intensity of the light beams emitted from the LD-CHIP 102 so as to cancel influences of thermal expansions, thermal contractions, vibrations and impacts of the respective components, the vibrations of the lenses and the vibrations of the fibers, which are caused on the front side of the LD-CHIP 102.

The optical communication module 100 enables the stable optical output level to be kept against optical fluctuations (a change in temperature, an external stress) caused on the front side. The optical communication module 100, for instance, if the intensity of the light beams entering the optical fiber 108 changes as the ferrule vibrates, receives the light beams on the front side, which are to be reflected by the filter 112, whereby the output of the LD-CHIP 102 can be controlled in a way that reflects the change in intensity of the light beams. The optical communication module 100 can control the output of the LD-CHIP 102 by feeding back the influences due to the optical fluctuations on the front side.

The optical communication module 100 outputs the light beams affected by the change in temperature and by the optical fluctuations on the front side. Further, the M-PD 110 similarly receives the light beams affected by the change in temperature and by the optical fluctuations on the front side. The APC circuit 130 controls, based on the intensity of the light beams received by the M-PD 110, the intensity of the light beams emitted from the LD-CHIP 102. The APC circuit 130 controls the intensity of the light beams so that the intensity of the light beams received by the M-PD 110 gets fixed, thereby enabling the optical communication module 100 to output the stable light beams even when affected by the change in temperature and by the optical fluctuations on the front side.

### Second Embodiment

Next, a second embodiment will be described. The second embodiment has common points to the first embodiment. Accordingly, the discussion will be focused on different points, while the descriptions of the common points are omitted.

In the second embodiment, the ferrule involves using a transparent material.

(Example of Configuration)

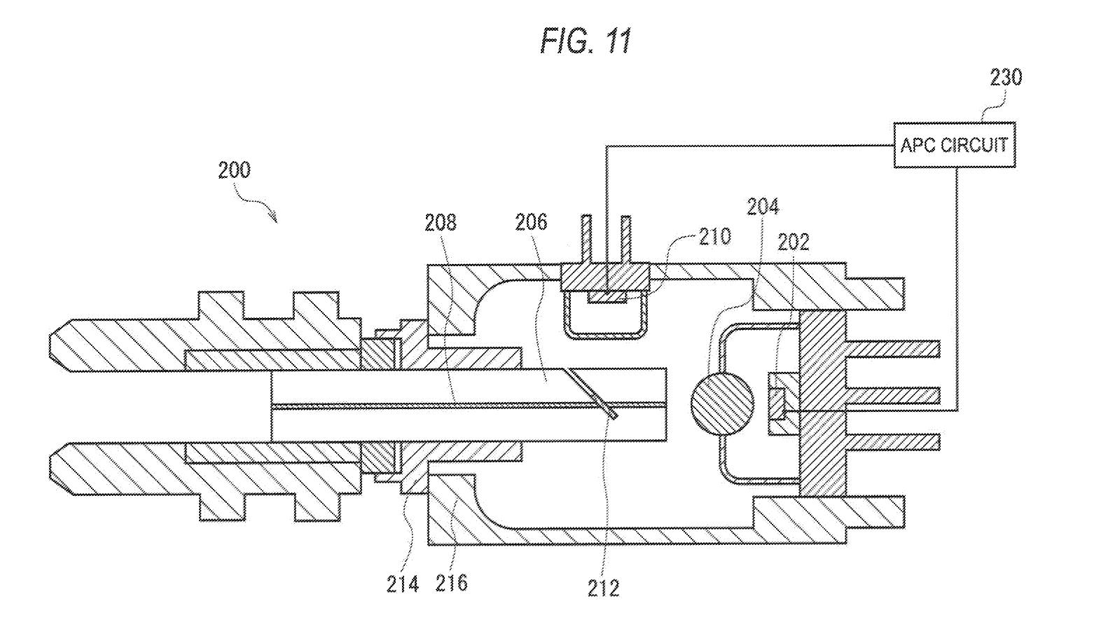

FIG. 11 is a view illustrating an example of a sectional structure parallel to the optical axis of the optical communication module. An optical communication module 200 transmits the optical signal. The optical communication module 200 in FIG. 11 includes an LD-CHIP 202, a lens 204, a ferrule 206, an optical fiber 208, an M-PD 210, a filter 212 and an APC circuit 230. The optical fiber 208 is held within a housing 216 of the optical communication module 200 through the ferrule 206 and a sleeve 214.

The ferrule 206 is a transparent ferrule which uses the transparent material. The transparent material such as a transparent resin and glass is employed as the material of the ferrule 206. The transparent material connotes a material that is penetrated by the light beams having a wavelength band used for the optical communications, which involve using at least the optical fiber. The hole (vertical hole) for taking out the light beams reflected by the filter is bored in the ferrule 106 of the first embodiment, however, the vertical hole may not be bored in the ferrule 206 of the second embodiment. This is because the optical communication module 200 can receive the light beams reflected by the filter 212 with the M-PD 210 owing to the use of the transparent material without forming the vertical hole. Hence, the manufacture of the ferrule 206 is facilitated. An external configuration of the ferrule 206 is substantially the same as the external configuration of the ferrule 106 except the portion of the vertical hole.

In the ferrule 206, similarly to the ferrule 106 in FIG. 6A etc, one of the flat circular surfaces of the cylinder is defined as a lower surface, while the other is defined as an upper surface. The upper surface side of the ferrule 206 is installed on the side of the LD-CHIP 202 in the optical communication module 200. Moreover, a curved surface of the cylinder is defined as a side surface. A straight line, which embraces a line segment extending from the center of the lower surface up to the center of the upper surface, is defined as the central axis. A portion vicinal to the upper surface of the ferrule 206 is also called an end portion.

When the light beams enter from the upper surface side of the ferrule 206, the light beams might become noises against the light beams traveling through within the optical fiber 208. Accordingly, it is preferable to eliminate the light beams entering from other than the optical fiber 208.

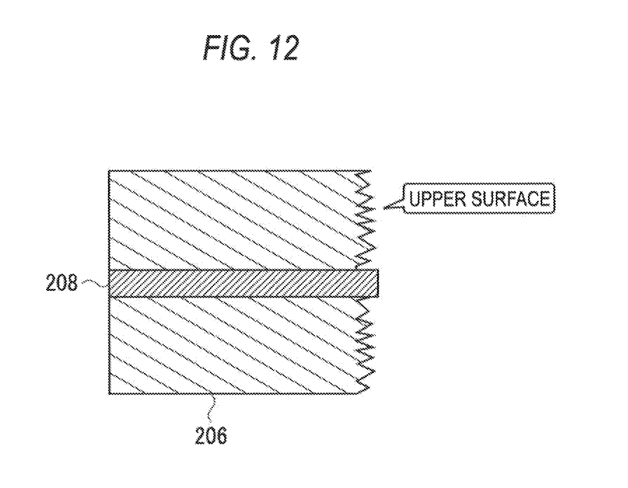

FIG. 12 is a view depicting an example (1) of a light shielding structure of the transparent ferrule. FIG. 12 is the view illustrating an example of the section passing through the central axis in the vicinity of the upper surface of the transparent ferrule. The light beams emitted from the LD-CHIP enter from the right side in FIG. 12. The transparent ferrule in FIG. 12 has an upper surface that is roughly polished beforehand. The roughly-polished upper surface causes irregular reflections of the light beams on the upper surface itself, and the light beams become hard to enter the ferrule. Further, the optical fiber inserted into the transparent ferrule is inserted in a way that slightly projects from the roughly-polished upper surface. The end face of the optical fiber is polished.

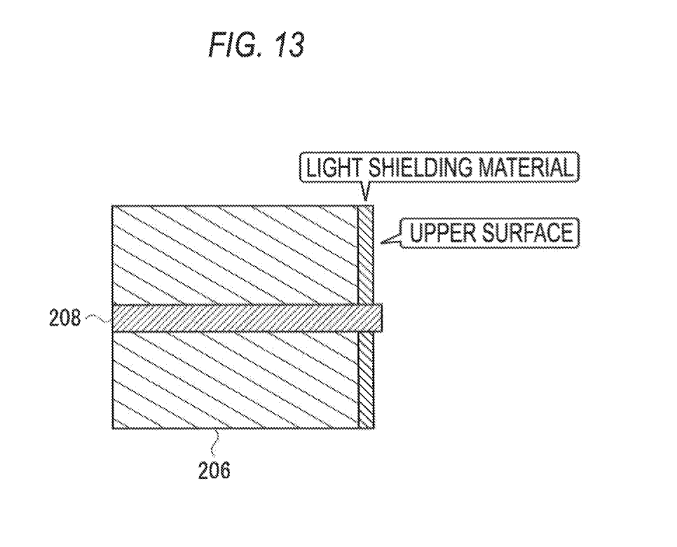

FIG. 13 is a view illustrating an example (2) of the light shielding structure of the transparent ferrule. FIG. 13 is the view illustrating an example of the section passing through the central axis in the vicinity of the upper surface of the transparent ferrule. The light beams emitted from the LD-CHIP enter from the right side in FIG. 13. In the example of FIG. 12, the transparent ferrule in FIG. 12 has the roughly-polished upper surface, however, the example in FIG. 13 is that the upper surface is shielded from the light beams by covering a light shielding material over the upper surface. For example, a black resin is used as the light shielding material. Moreover, the optical fiber inserted into the transparent ferrule is inserted so as to project slightly from the upper surface covered with the black resin. The end face of the optical fiber is polished. Further, the black resin and the optical fiber may also be polished together. The upper surface of the ferrule excluding the portion of the optical fiber is thereby shielded from the light beams.

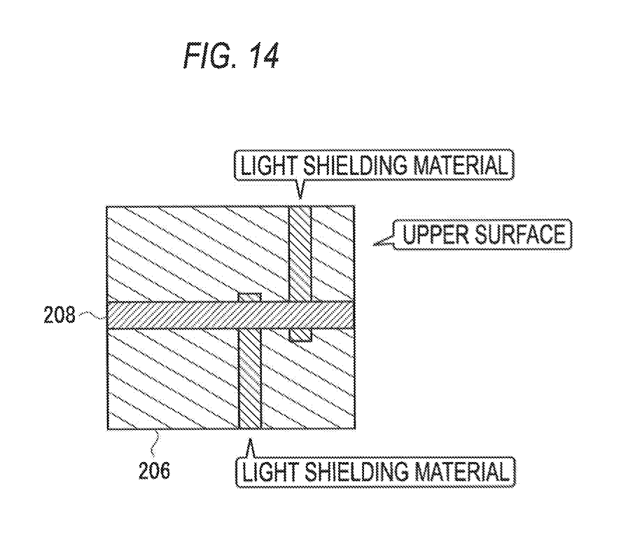

FIG. 14 is a view illustrating an example (3) of the light shielding structure of the transparent ferrule. FIG. 14 is the view illustrating an example of the section passing through the central axis in the vicinity of the upper surface of the transparent ferrule. The light beams emitted from the LD-CHIP enter from the right side in FIG. 14. In the example of FIG. 14, two holes each taking substantially a semicircular shape embracing the central axis are bored to intersect at a right angle the central axis in the vicinity of the upper surface. A distance between one hole and the upper surface is set different from a distance between the other hole and the upper surface. When viewing the transparent ferrule from the upper surface side, the two semicircular holes are disposed so as not to substantially overlap with each other. The light shielding materials are inserted into the two semicircular holes. For example, the black resin is used as the light shielding material. This light shielding material makes the light beams entering from the upper surface side of the transparent ferrule invisible from the lower surface side. Further, a hole, through which the optical fiber is allowed to pass, is bored along the central axis. The optical fiber is inserted into the bored hole and hardened therein. Thereafter, the upper surface side is polished. The light beams entering from the upper surface of the ferrule are cut off by the area excluding the portion of the optical fiber.

For example, the transparent ferrule in FIG. 12, 13 or 14 can be used as the ferrule 206 of the optical communication module 200. The lower surface of the ferrule 206 may have, similarly to the upper surface of the ferrule 206, the light shielding structures as in FIGS. 12 through 14. Each of the light shielding structures of the transparent ferrule as in FIGS. 12 through 14 is an example of a light shielding portion.

(Operation, Effect of Second Embodiment)

The transparent material is employed for the ferrule 206 of the optical communication module 200. The transparent material is used for the ferrule 206, whereby the light beams on the front side can be received by the M-PD 210 without boring the vertical hole in the ferrule 206. Further, the upper surface side of the ferrule 206 takes the light shielding structure as in FIGS. 12, 13 and 14, thereby reducing an error due to the noises caused by the light beams entering the transparent ferrule.

### Third Embodiment

Next, a third embodiment will be discussed. The third embodiment has common points to the first and second embodiments. Accordingly, the discussion will be focused on different points, while the descriptions of the common points are omitted.

In the third embodiment, the optical communication module has a configuration on the reception side. The optical communication module, which is incorporated into, e.g., an optical communication device, converts the electric signal into the optical signal and vice versa, and transmits and receives the optical signal. Moreover, the optical communication module, which is connected to the light transmission path (the optical fiber etc) via another ferrule, can transmit and receive the optical signal to and from other devices.

(Example of Configuration)

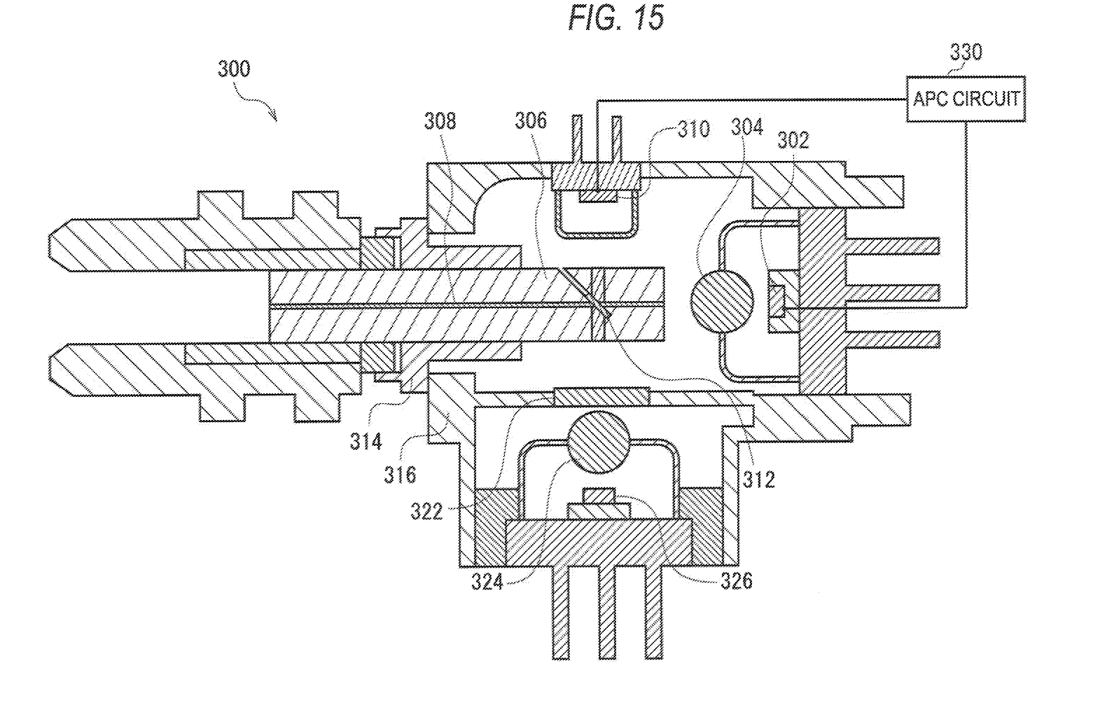

FIG. 15 is a view illustrating an example of the sectional structure parallel to the optical axis of the optical communication module. An optical communication module 300 transmits and receives the optical signal. The optical communication module 300 in FIG. 15 includes an LD-CHIP 302, a first lens 304, a ferrule 306, an optical fiber 308, an M-PD 310, a first filter 312 and an APC circuit 330. The optical communication module 300 includes a second filter 322, a second lens 324 and a PD 326. The optical fiber 308 is held within a housing 316 of the optical communication module 300 through the ferrule 306 and a sleeve 314.

The ferrule 306 is assembled in the same way as the ferrule 106 in the first embodiment is. A vertical hole (which passes through the central axis and has an angle of 90 degrees with the central axis) bored in the ferrule 306, however, pieces the ferrule 306 throughout. The light beams coming from the LD-CHIP 302 pass through the vertical hole on one side, while the light beams inputted from the outside pass through the vertical hole on the other side.

The first filter 312 transmits a large proportion but reflects some proportion of the light beams entering the optical fiber 308 from the LD-CHIP 302. Moreover, the light beams inputted via the optical fiber 308 from the outside (the left side in FIG. 15) are reflected by the first filter 312. The second filter 322 transmits the light beams having a predetermined wavelength in the reflected light beams. Further, the light beams penetrating the second filter 322 are converged by the second lens 324 and received by the PD 326. The light beams received by the PD 326 are converted into the electric signals.

The first filter 312 involves using a filter having characteristics demonstrated by, e.g., a graph in FIG. 5. It is herein assumed that a wavelength of the light beams output from the LD-CHIP 302 is 1310 nm, and a wavelength of the light beams inputted via the optical fiber 308 from the outside is 1490 nm. At this time, the first filter 312 transmits a large proportion of the light beams entering the optical fiber 308 from the LD-CHIP 302. Moreover, some proportion of the light beams entering the optical fiber 308 from the LD-CHIP 302 are reflected by the first filter 312 and enter the M-PD 310. Further, the light beams inputted via the optical fiber 308 from the outside are reflected by the first filter 312 and enter the PD 326.

A wavelength different from the wavelength of the light beams inputted via the optical fiber 308 from the outside and received by the PD 326 is used as the wavelength of the light beams emitted from the LD-CHIP 302.

The second filter 322 cuts off the light beams emitted from the LD-CHIP 302 but transmits the light beams inputted via the optical fiber 308 from the outside. Namely, the second filter 322 cuts off the wavelength of the light beams emitted from the LD-CHIP 302 buts transmits the wavelength of the light beams inputted via the optical fiber 308 from the outside. The wavelength demultiplexing multi-layered flat glass as in FIG. 4 can be used as the second filter 322.

The second lens 324 converges the light beams penetrating the second filter 322 at the PD 326. The second lens 324 can be exemplified such as a spherical lens, an aspherical lens and a ball lens. The second lens 324 is not limited to these types of lenses.

The PD 326 is a light receiving element. The PD 326 receives the light beams inputted via the optical fiber 308 from the outside. The received light beams are converted into the electric signals and then processed.

(Operation, Effect of Third Embodiment)

The optical communication module 300 outputs the light beams (the optical signals) emitted from the LD-CHIP 302 to the outside through the first filter 312 etc. Some proportion of the light beams (the optical signals) emitted from the LD-CHIP 302 are reflected by the first filter 312 and enter the M-PD 310. The APC circuit 330 controls the intensity of the light beams emitted from the LD-CHIP 302 on the basis of the intensity of the light beams received by the M-PD 310. The APC circuit 330 controls the intensity of the light beams emitted from the LD-CHIP 302 so that the intensity of the light beams received by the M-PD 310 becomes fixed.

Furthermore, the first filter 312 reflects the light beams (the optical signals) inputted via the optical fiber 308 from the outside (the left side in FIG. 15). The light beams reflected by the first filter 312 are received by the PD 326. The first filter 312 can extract the light beams on the reception side and can extract the light beams on the transmission side.

The optical communication module 300 enables the stable optical output level to be kept against the optical fluctuations (the change in temperature, the external stress) caused on the front side even in the case of including the configuration for receiving the optical signals from the outside.

### Fourth Embodiment

Next, a fourth embodiment will be discussed. The fourth embodiment has common points to the first through third embodiments. Accordingly, the discussion will be focused on different points, while the descriptions of the common points are omitted.

In the fourth embodiment, the optical communication module has the configuration on the reception side, and the ferrule and the M-PD take an integral-type structure.

(Example of Configuration)

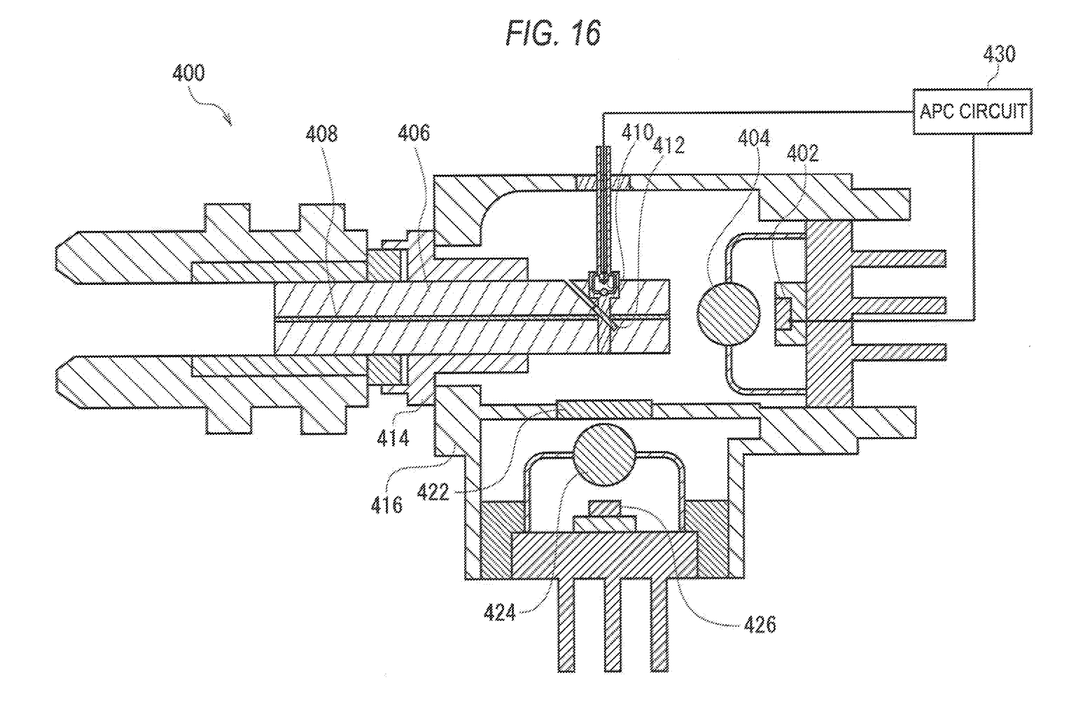

FIG. 16 is a view illustrating an example of the sectional structure parallel to the optical axis of the optical communication module. An optical communication module 400 transmits and receives the optical signal. The optical communication module 400 in FIG. 16 includes an LD-CHIP 402, a first lens 404, a ferrule 406, an optical fiber 408, an M-PD 410, a first filter 412 and an APC circuit 430. The optical communication module 400 includes a second filter 422, a second lens 424 and a PD 426. The optical fiber 408 is held within a housing 416 of the optical communication module 400 through the ferrule 406 and a sleeve 414.

A hole piercing the central portion of the circle of the cylinder is thus bored in the ferrule 406, and the optical fiber 408 is allowed to pass through this hole. Moreover, the first filter 412 is embedded in the ferrule 406. The first filter 412 is embedded so as to cut (intercept) the optical fiber 408.

A hole for taking out the light beams reflected by the first filter 412 is bored in the ferrule 406. The hole for taking out the light beams reflected by the first filter 412 is, e.g., 1.0 mm in diameter. Further, a hole for installing the M-PD 410 is bored in the ferrule 406. The hole for installing the M-PD 410 is provided in the vicinity of the side surface of the ferrule 406 in a way that expands the hole for taking out the light beams reflected by the first filter 412.

The M-PD 410 is a light receiving element for a monitor. The M-PD 410 receives mainly the light beams emitted from the LD-CHIP 402. A lens for converging the light beams may also be provided in front of the M-PD 410. The M-PD 410 receives the light beams reflected by the first filter 412.

The M-PD 410 is mounted on the ferrule 406. Namely, the M-PD 410 is fitted directly to the ferrule 406. If the ferrule 406 vibrates due to the external stress etc, the M-PD 410 is mounted on the ferrule 406 and therefore vibrates together with the ferrule 406. Hence, the M-PD 410 can receive, even when the ferrule 406 gets vibrating, the light beams reflected by the first filter 412 in the same way as when the ferrule 406 does not vibrate. If the M-PD is not fixed to the ferrule and when the ferrule vibrates, a part or the whole of the light beams reflected by the first filter 412 cannot be received as the case may be.

(Example of Assembling Ferrule)

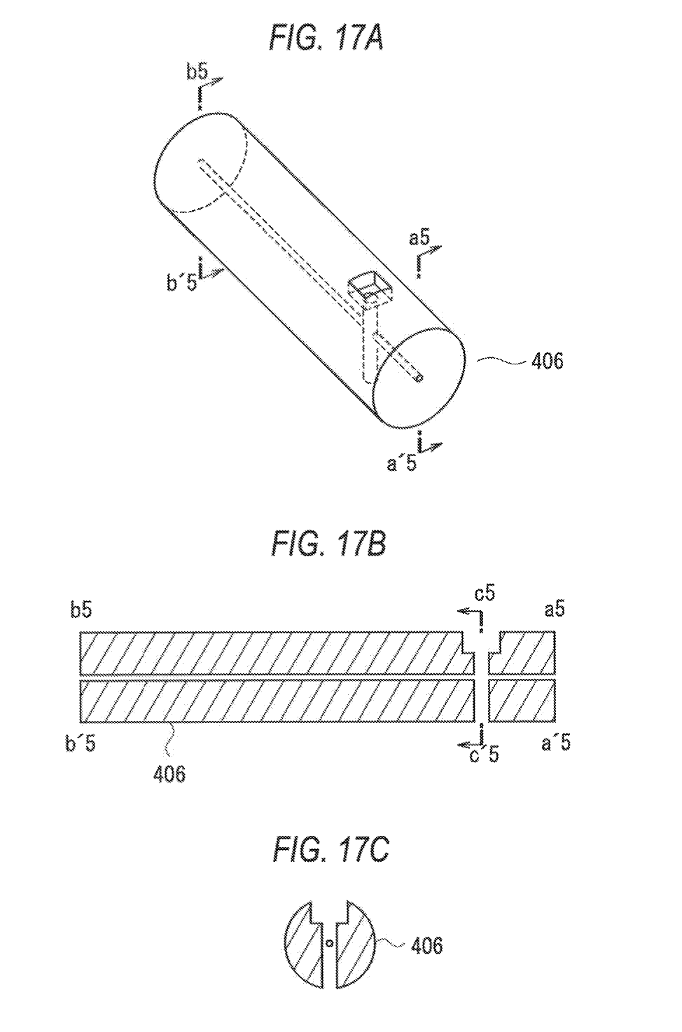

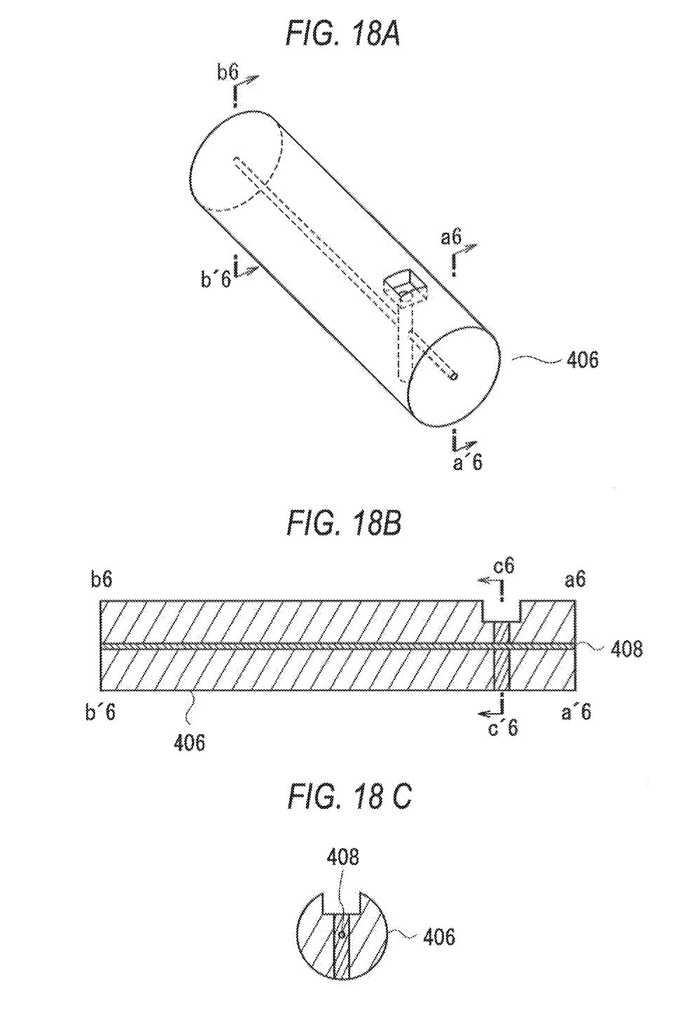

FIGS. 17A through 21C are views each depicting an example of how the ferrule 406 is assembled. The optical fiber 408 and the first filter 412 are built in the ferrule 406. FIG. 17A is a perspective view of the ferrule 406 etc. The near side of the ferrule 406 in FIG. 17A is the side of the end face on which the light beams coming from the LD-CHIP 402 get incident. FIG. 17B is a sectional view of the ferrule 406 etc on the plane embracing a line segment a5-a′5 and a line segment b5-b′5 in FIG. 17A. FIG. 17C depicts a section of the ferrule 406 etc on the plane embracing a line segment c5-c′5 in FIG. 17B and being orthogonal to the section in FIG. 17B. The same view configuration is applied to other similar views (FIGS. 18A, 18B and 18C, etc).

As in FIGS. 17A, 17B and 17C, the ferrule material such as the zirconia ceramics is formed in the cylindrical shape. One of the flat circular surfaces of the cylinder is defined as the lower surface, while the other is defined as the upper surface. The right side in FIG. 17B is defined as the lower surface side, while the left side is defined as the upper surface side. The upper surface side of the ferrule 406 is installed on the side of the LD-CHIP 402 in the optical communication module 400. Furthermore, the curved surface of the cylinder is defined as the side surface. The straight line, which embraces the line segment extending from the center of the lower surface up to the center of the upper surface, is defined as the central axis.

As in FIGS. 17A, 17B and 17C, the hole (the through-hole, the horizontal hole), through which the optical fiber is allowed to pass, is bored into the central axis of the cylinder. The hole takes the cylindrical shape, and the center of the hole is coincident with the central axis. If the optical fiber to be used is 125 μm in diameter, the diameter of the hole is set equal to or slightly larger than 125 μm. For example, the diameter of the hole is 125.5 μm. If the section of the optical fiber is not circular, the horizontal hole taking the shape matching with the section of the optical fiber may also be bored.

Moreover, as in FIGS. 17A, 17B and 17C, the vertical hole is bored till passing through the hole for letting through the optical fiber from the side surface of the ferrule 406 and reaching the opposite side. Namely, the hole is bored to pass through the central axis from the side surface of the optical fiber 408 down to the side surface on the opposite side. Some proportion of the light beams entering the optical fiber 408 are taken out of the thus-bored vertical hole. The angle made by the bored vertical hole and the central axis is, e.g., 90 degrees. The vertical hole may take the cylindrical shape in principle and may also take other shapes.

Furthermore, as in FIGS. 17A, 17B and 17C, a hole for fixing the M-PD 410 is bored so as to expand the vertical hole. The hole is bored in a manner that matches with the shape of the M-PD 410.

Next, as in FIGS. 18A, 18B and 18C, the optical fiber 408 is inserted into the through-hole (the horizontal hole) filled with the bonding agent. The optical fiber 408 is fixed to the ferrule 406 upon hardening the bonding agent. The optical fiber 408 is inserted from the lower surface of the ferrule 406 up to the upper surface. The end faces (the upper and lower surfaces) of the ferrule 406 and the optical fiber 408 are polished.

Moreover, the vertical hole excluding the portion to which the M-PD 410 is fixed is filled with the transparent resin. At this time, it is preferable that the resin having the same refractive index as the refractive index of the cladding portion of the optical fiber is used as the transparent resin. Further, on the occasion of hardening the optical fiber, the transparent bonding agent is used to fill the vertical hole, whereby the optical fiber may be thus hardened simultaneously with fixing this optical fiber. The transparent resin may not fill the vertical hole.

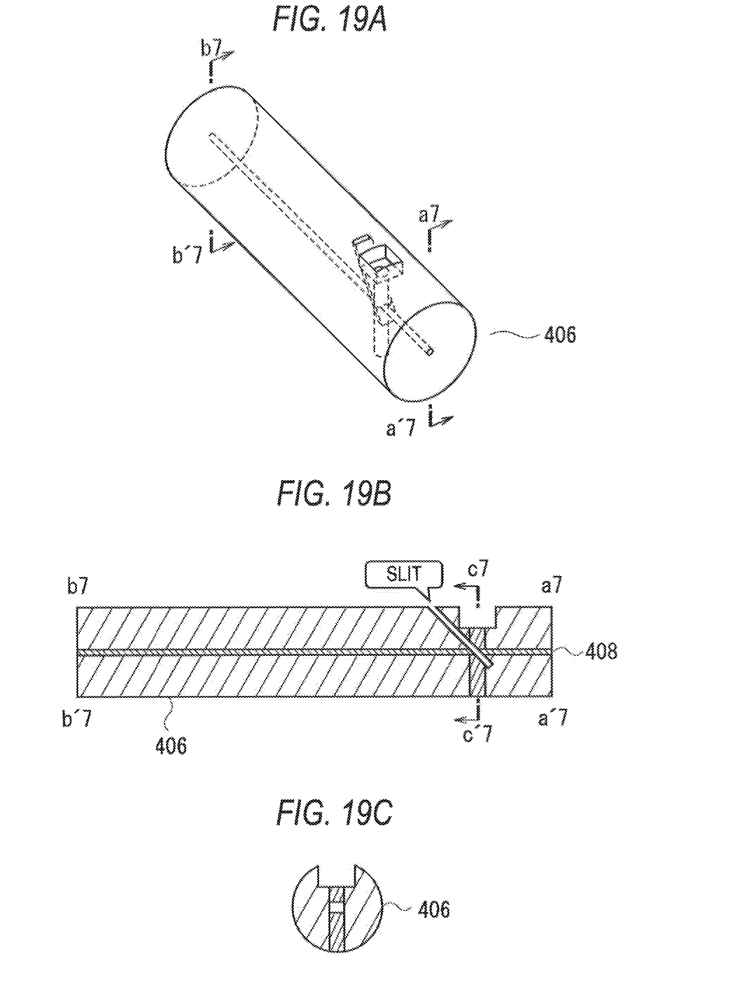

Next, as in FIGS. 19A, 19B and 19C, the slit, into which to insert the first filter 412, is cut open from the side surface of the ferrule 406. An angle made by the slit and the central axis is, e.g., 45 degrees. The slit is formed corresponding to the size of the first filter 412. The slit is cut open toward the connecting portion (intersection) between the central axis and the vertical hole. The slit receiving the insertion of the first filter 412 is worked by, e.g., the dicing technique. At this time, the optical fiber is cut off.

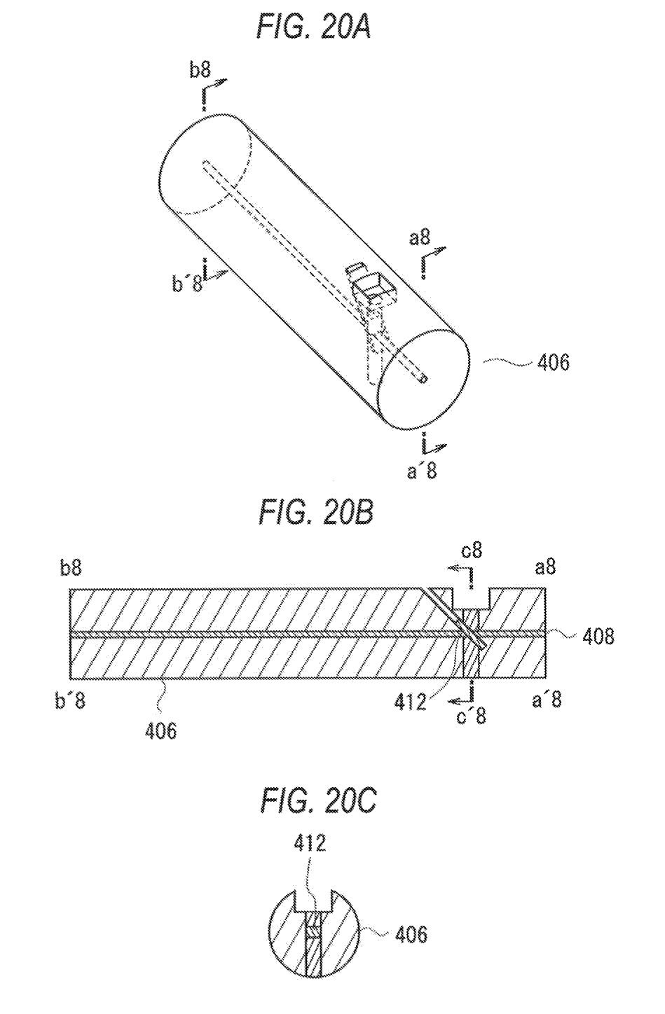

Next, as in FIGS. 20A, 20B and 20C, the first filter 412 is inserted into the slit. The first filter 412 is hardened by, e.g., the bonding agent. As the sizes of the first filter 412 and the slit become smaller, the friction resistance between the first filter 412 and the ferrule 406 gets smaller, thereby facilitating the insertion of the first filter 412.

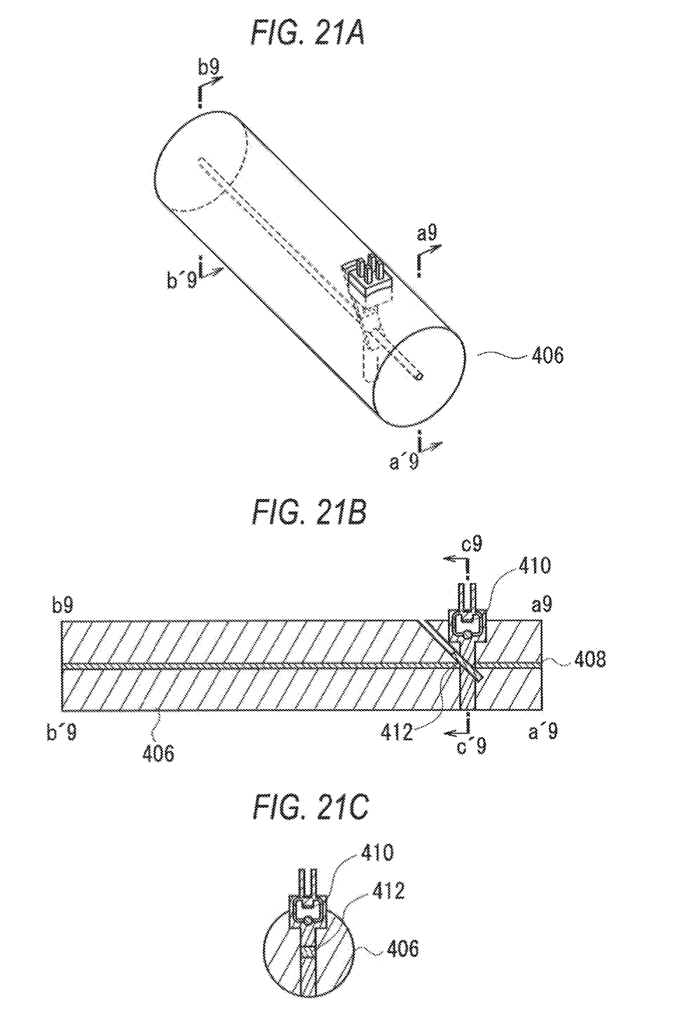

Next, as in FIGS. 21A, 21B and 21C, the M-PD 410 is fixed by the bonding agent into the hole bored in a way that matches with the shape of the M-PD 410. A relative position between the M-PD 410 and the first filter 412 is thereby fixed. The M-PD 410 is installed near the first filter 412, whereby the light beams reflected by the first filter 412 can be received without any leakage even when a size of the light receiving portion of the M-PD 410 is small.

(Operation, Effect of Fourth Embodiment)

In the optical communication module 400, the first filter 412 and the M-PD 410 are fixed to the ferrule 406. The first filter 412 and the M-PD 410 are fixed to the ferrule 406, and these components move together, and consequently the relative position between the first filter 412 and the M-PD 410 does not change. Hence, even when the ferrule 406 vibrates due to the external stress etc, the light beams reflected by the first filter 412 are not affected by the vibrations but are received by the M-PD 410. Furthermore, the first filter 412 and the M-PD 410 are fixed to the ferrule 406, thereby increasing a light convergence rate at the M-PD 410.

The intensity of the light beams received by the M-PD 410 depends on how much the light beams emitted from the LD-CHIP 402 are affected till being reflected by the first filter 412. Hence, the optical communication module 400 can control the intensity of the light beams emitted from the LD-CHIP 402 on the basis of how much the light beams emitted toward the front side from the LD-CHIP 402 are affected till being reflected by the first filter 412.

The optical communication module 400 enables the stable output to be acquired even when causing the change in temperature and the external stress on the front side of the LD-CHIP 402.

The configuration of fixing the LD-CHIP to the ferrule as in the optical communication module 400 may be applied to the optical communication module including none of the configuration for receiving the optical signals from the outside as in the first and second embodiments.

### Fifth Embodiment

Next, a fifth embodiment will be described. The fifth embodiment has common points to the first through fourth embodiments. Accordingly, the discussion will be focused on different points, while the descriptions of the common points are omitted.

In the fifth embodiment, the transparent material is used for the ferrule.

(Example of Configuration)

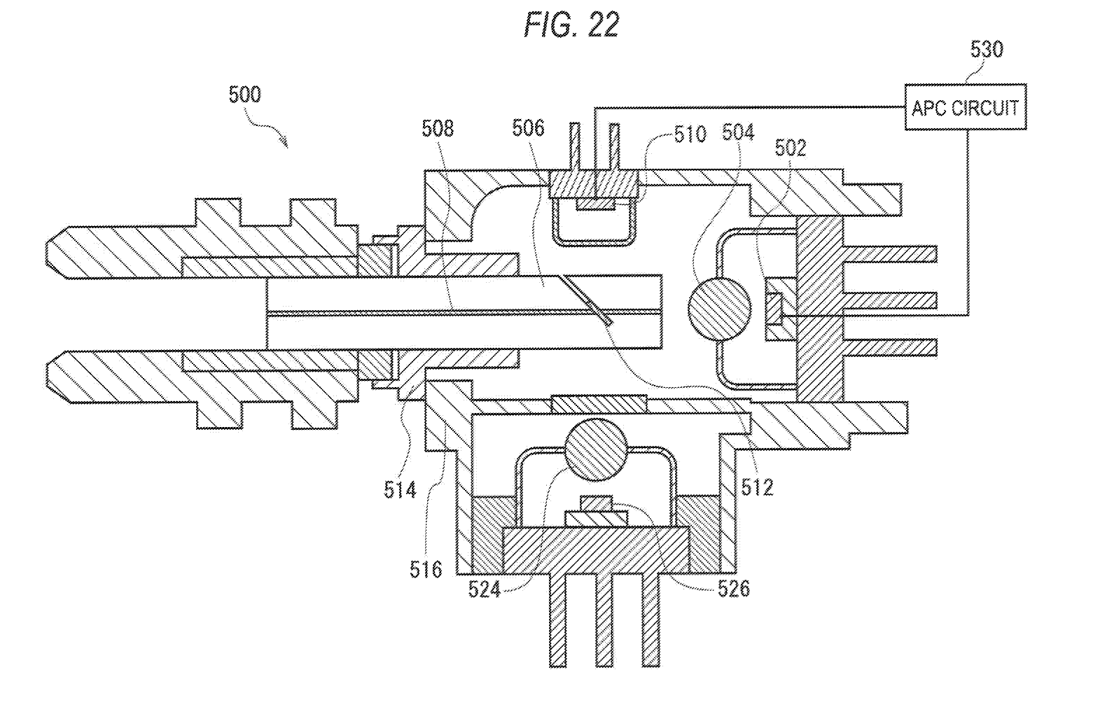

FIG. 22 are a view illustrating an example of a sectional structure parallel to the optical axis of the optical communication module. An optical communication module 500 transmits and receives the optical signal. The optical communication module 500 in FIG. 22 includes an LD-CHIP 502, a first lens 504, a ferrule 506, an optical fiber 508, an M-PD 510, a first filter 512 and an APC circuit 530. The optical communication module500 includes a second filter 522, a second lens 524 and a PD 526. The optical fiber 508 is held within a housing 516 of the optical communication module 500 through the ferrule 506 and a sleeve 514.

The ferrule 506 is the transparent ferrule which uses the transparent material. The transparent material such as a transparent resin and glass is employed as the material of the ferrule 506. The hole (vertical hole) for taking out the light beams reflected by the first filter is bored in the ferrule 306 of the third embodiment, however, the vertical hole may not be bored in the ferrule 506 of the fifth embodiment. This is because the optical communication module 500 can receive the light beams reflected by the first filter 512 with the M-PD 510 and PD 526 owing to the use of the transparent material without forming the vertical hole. Hence, the manufacture of the ferrule 506 is facilitated. The light shielding structure as in FIGS. 12, 13 and 14 of the second embodiment is applicable to the ferrule 506.

(Operation, Effect of Fifth Embodiment)

The transparent material is employed for the ferrule 506 of the optical communication module 500. The transparent material is used for the ferrule 506, whereby the light beams on the front side can be received by the M-PD 510 without boring the vertical hole in the ferrule 506. Further, similarly, the transparent material is used for the ferrule 506, whereby the light beams from the outside can be received by the PD 526 without boring the vertical hole in the ferrule 506.

### Sixth Embodiment

Next, a sixth embodiment will be discussed. The sixth embodiment has common points to the first through fifth embodiments. Accordingly, the discussion will be focused on different points, while the descriptions of the common points are omitted.

In the sixth embodiment, the ferrule involves using the transparent material, and the ferrule and the M-PD take an integral-type structure.

(Example of Configuration)

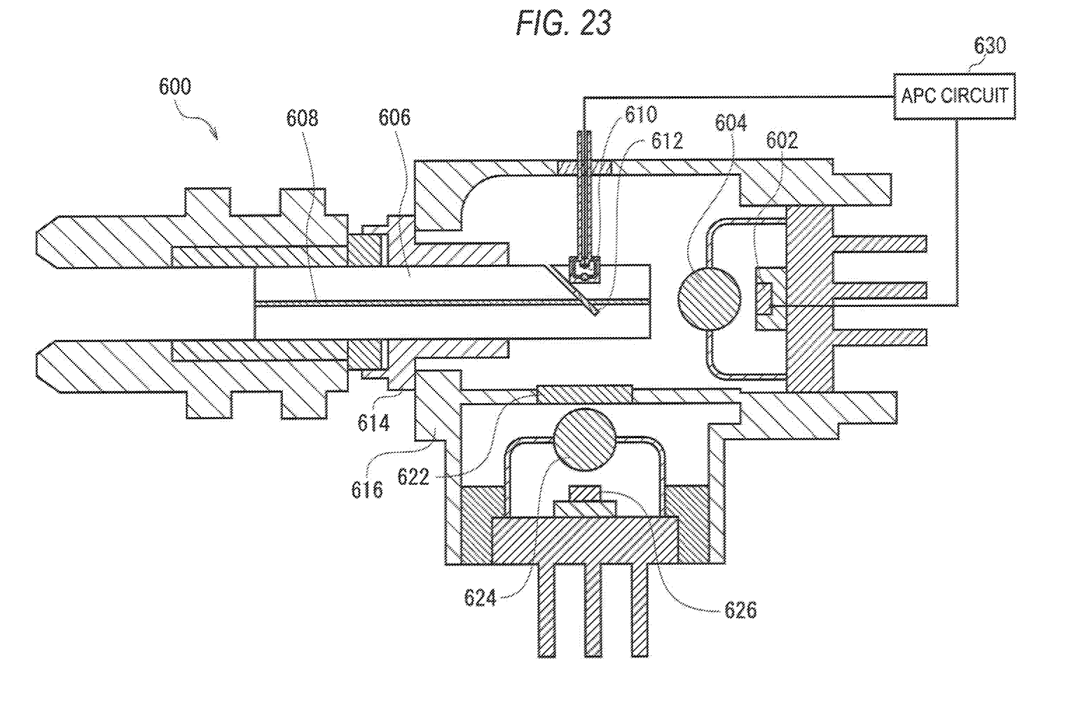

FIG. 23 is a view illustrating an example of the sectional structure parallel to the optical axis of the optical communication module. An optical communication module 600 transmits and receives the optical signal. The optical communication module 600 in FIG. 23 includes an LD-CHIP 602, a first lens 604, a ferrule 606, an optical fiber 608, an M-PD 610, a first filter 612 and an APC circuit 630. The optical communication module 600 includes a second filter 622, a second lens 624 and a PD 626. The optical fiber 608 is held within a housing 616 of the optical communication module 600 through the ferrule 606 and a sleeve 614.

The ferrule 606 is the transparent ferrule using the transparent material. Similarly to the ferrule 506 in the fifth embodiment, the vertical hole may not be bored in the ferrule 606. Further, in the (configuration of) ferrule 606, similarly to the ferrule 406 in the fourth embodiment, the M-PD 610 is fixed to the ferrule 606. With this configuration, the optical communication module 600 exhibits at least the same operations and effects as those of the optical communication modules in the fourth and fifth embodiments.

### Seventh Embodiment

Next, a seventh embodiment will be discussed. The seventh embodiment has common points to the first through sixth embodiments. Accordingly, the discussion will be focused on different points, while the descriptions of the common points are omitted.

The seventh embodiment adopts not the receptacle type of optical communication module as in the first through sixth embodiments but a pigtail type of optical communication module.

(Example of Configuration)

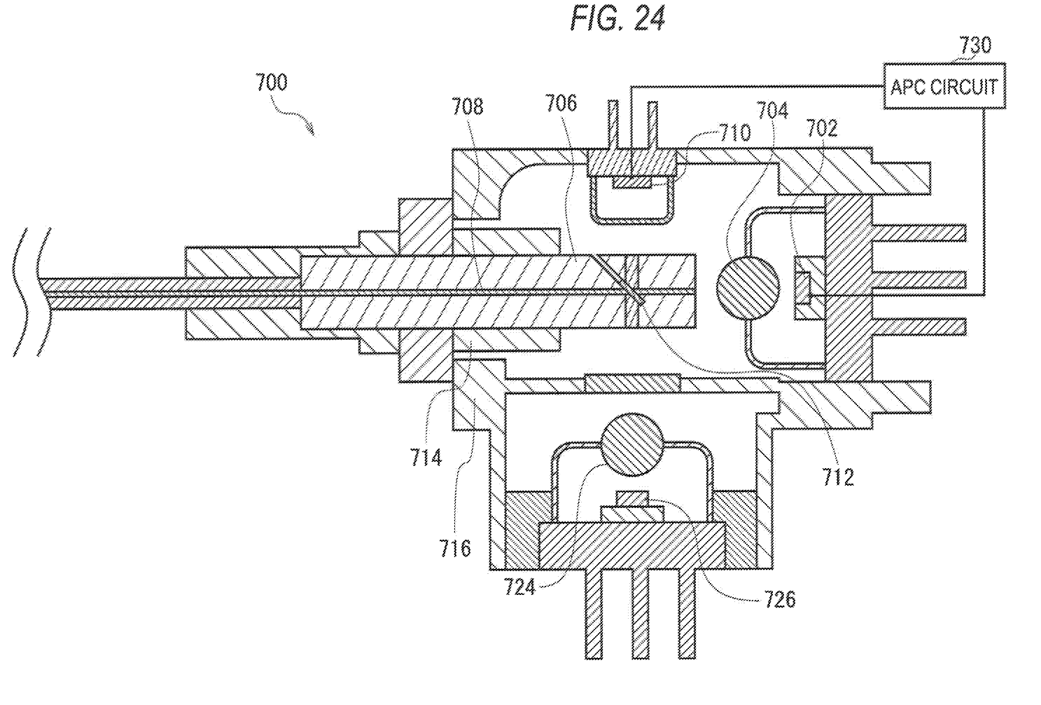

FIG. 24 is a view illustrating an example of the sectional structure parallel to the optical axis of the optical communication module. An optical communication module 700 transmits and receives the optical signal. The optical communication module 700 in FIG. 24 includes an LD-CHIP 702, a first lens 704, a ferrule 706, an optical fiber 708, an M-PD 710, a first filter 712 and an APC circuit 730. The optical communication module 700 includes a second filter 722, a second lens 724 and a PD 726. The optical fiber 708 is held within a housing 716 of the optical communication module 700 through the ferrule 706 and a sleeve 714.

The optical communication modules in the first through sixth embodiments are the receptacle type of optical communication modules. In the receptacle type of optical communication module, the ferrule on the side of an external wire is press-fitted into the optical communication module and is thus optically connected to the ferrule of the optical communication module. In the receptacle type of optical communication module, the connecting portion between the ferrule of the optical communication module and the ferrule on the side of the external wire is called a receptacle portion.

The optical communication module 700 is an optical communication module in which the receptacle portion of the optical communication module 300 in the third embodiment is replaced by the pigtail type. The receptacle portion of each of the optical communication modules in other embodiments may be replaced by the pigtail type. In the pigtail type, the optical fiber on the side of the external wire gets integral with the optical fiber within the ferrule of the optical communication module without being cut off. The optical communication module is configured as the pigtail type, thereby preventing a loss at the connection portion with another ferrule.

The optical communication module, of which the receptacle portion is replaced by the pigtail type, also acquires the same operations and effects as those of the optical communication modules in other embodiments.

### Eighth Embodiment

Next, an eighth embodiment will be discussed. The eighth embodiment has common points to the first through seventh embodiments. Accordingly, the discussion will be focused on different points, while the descriptions of the common points are omitted.

In the eighth embodiment, a light path of the light beams inputted from the outside via the second filter is changed.

(Example of Configuration)

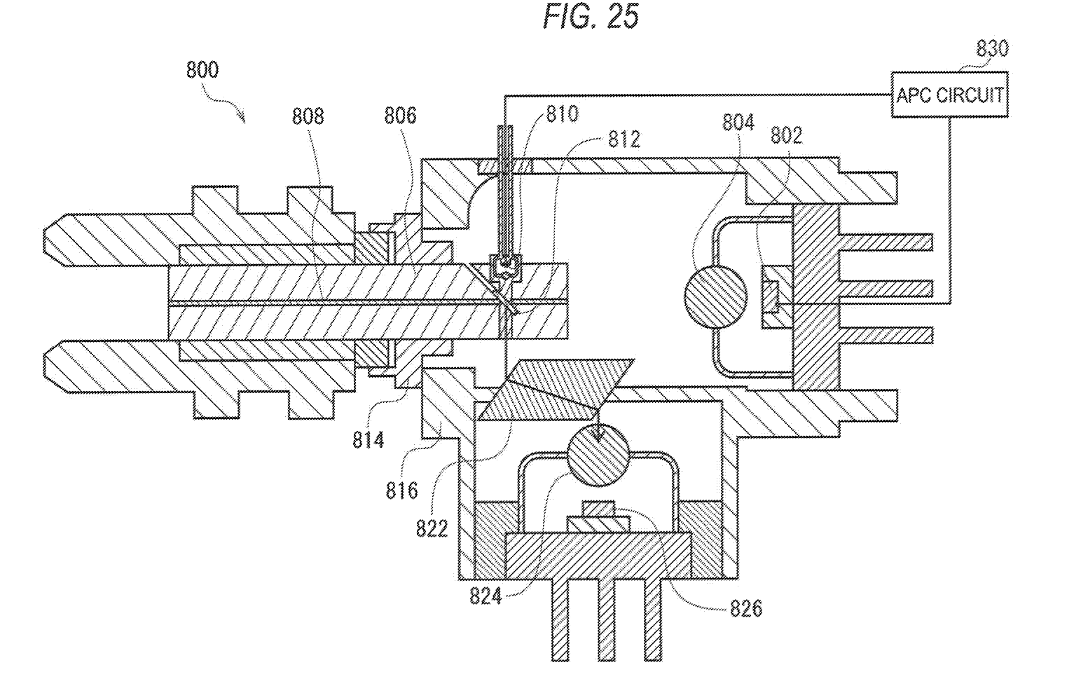

FIG. 25 is a view illustrating an example of the sectional structure parallel to the optical axis of the optical communication module. An optical communication module 800 transmits and receives the optical signal. The optical communication module 800 in FIG. 25 includes an LD-CHIP 802, a first lens 804, a ferrule 806, an optical fiber 808, an M-PD 810, a first filter 812 and an APC circuit 830. The optical communication module 800 includes a second filter 822, a second lens 824 and a PD 826. The optical fiber 808 is held within a housing 816 of the optical communication module 800 through the ferrule 806 and a sleeve 814.

Similarly to the ferrule 406 in the fourth embodiment, the M-PD 810 is built in the ferrule 806.

The second filter 822 cuts off the light beams emitted from the LD-CHIP 802 but transmits the light beams inputted via the optical fiber 808 from the outside. Namely, the second filter 822 cuts off the wavelength of the light beams emitted from the LD-CHIP 802 buts transmits the wavelength of the light beams inputted via the optical fiber 808 from the outside. The wavelength demultiplexing multi-layered flat glass as in FIG. 4 can be used as the second filter 822.

The second filter 822 receives the incidence, at a predetermined angle, of the light beams reflected by the first filter 812, thereby changing the light path of the incident light. Further, the second filter 822 gets the incident light to outgo at a predetermined angle, thereby making a PD 826 receive the light beams. The second filter 822 can change the light path of the light beams by deflecting the light beams. The light path of the light beams can be adjusted based on an angle between the incident light and the incident surface of the second filter 822, an angle between the outgoing light and the outgoing surface of the second filter 822, a refractive index of the second filter 822 and a size of the second filter 822.

The second filter 822 can, as in FIG. 25, change the light path of the light beams by adopting a shape such as of a prism.

(Operation, Effect of Eighth Embodiment)

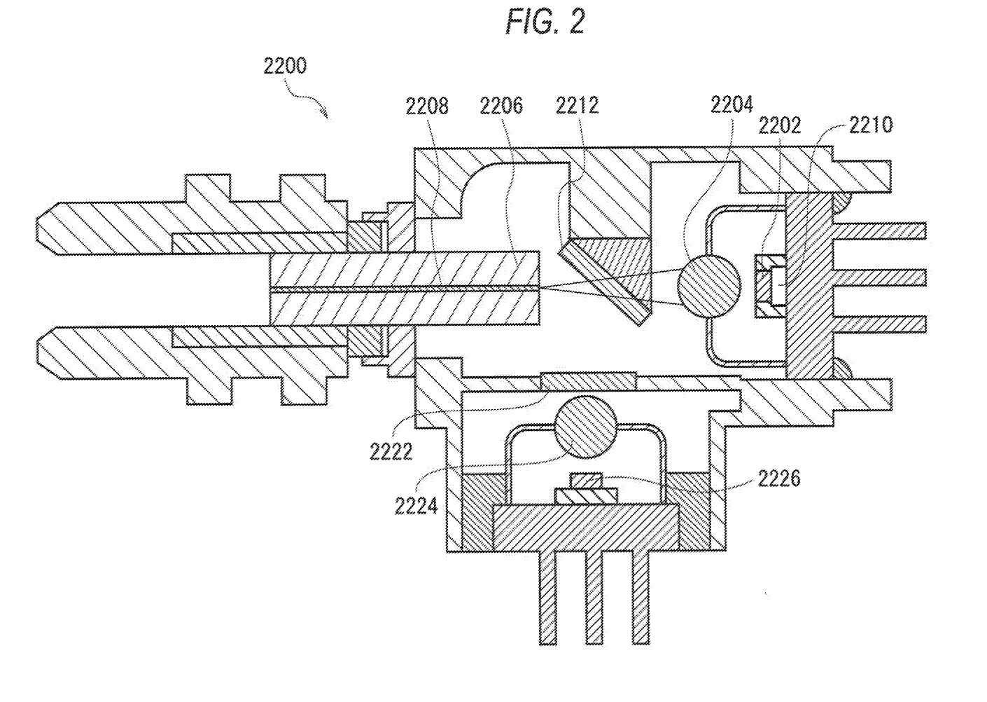

According to the optical communication module 800, a distance between the first lens 804 and the optical fiber 808 can be set similarly to the conventional optical communication module as in, e.g., FIG. 2. The distance between the first lens 804 and the optical fiber 808 can be set similarly to the conventional optical communication module, whereby the same components as those of the conventional optical communication module can be used for, e.g., the optical communication module 800. For example, the distance from the first lens 804 to the opto-coupling point remains unchanged, and therefore the same lens as that of the optical communication module can be used.

### Ninth Embodiment

Next, a ninth embodiment will be discussed. The ninth embodiment has common points to the first through eighth embodiments. Accordingly, the discussion will be focused on different points, while the descriptions of the common points are omitted.

The discussion on the ninth embodiment will deal with an optical communication device incorporating the optical communication module in any one of the first through eighth embodiments. The optical communication device performs the process of converting the optical signal into the electric signal and vice versa.

(Example of Configuration)

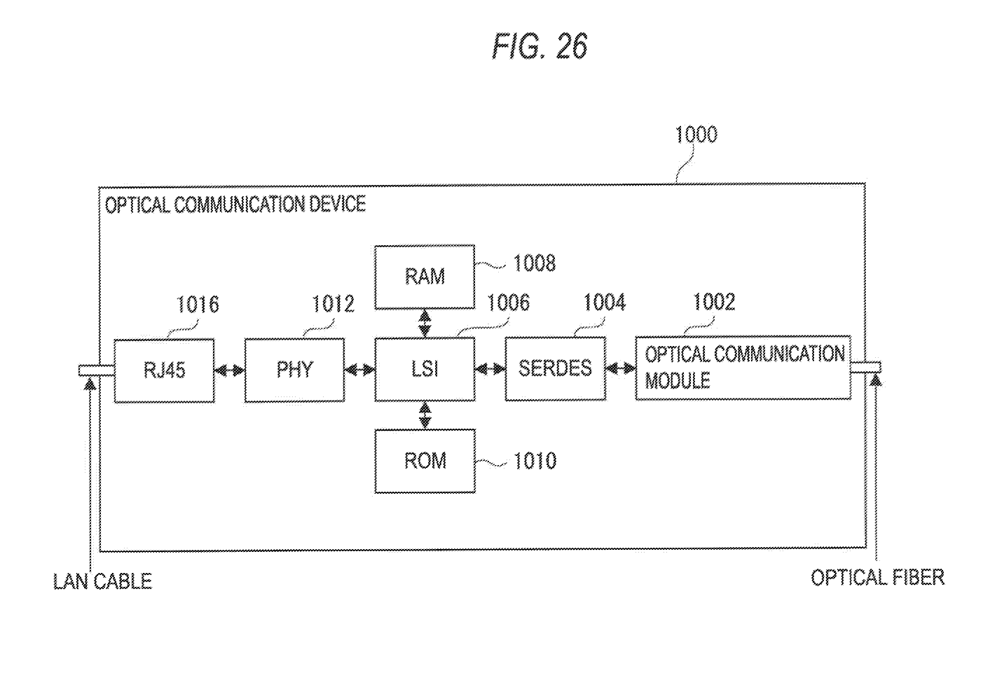

FIG. 26 is a view depicting an example of a configuration of the optical communication device. The optical communication device converts the signal format used for the optical communications into the signal format used within the LAN, and vice versa. An optical communication device 1000 includes an optical communication module 1002, a SERDES (Serialize Deserialize) 1004, an LSI 1006, a RAM 1008, a ROM 1010, a PHY 1012 and an RJ 45 (1016). The LSI 1006, the RAM 1008 and the ROM 1010 can operate each as a signal converting unit.

Herein, the signal flowing to the side of the optical communication module 1002 from the side of the RJ 45 (1016) is called the signal on the transmission side. Reversely, the signal flowing to the side of the RJ 45 (1016) from the side of the optical communication module 1002 is called the signal on the reception side.

The optical communication module 1002 is the optical communication module in any one of the first through eighth embodiments described above. The optical communication module 1002 converts the signal (serial signal) on the transmission side, which is received from the SERDES 1004, into the optical signal and outputs this optical signal to the outside device via the optical fiber. Further, the optical communication module 1002 converts the optical signal received from the outside device via the optical fiber into the electric signal, and outputs this electric signal to the SERDES 1004.

The SERDES 1004 is an interface between the optical communication module and the LSI. The SERDES 1004 serializes or deserializes the signal on the transmission side or the signal on the reception side. Namely, the SERDES 1004 converts the serial signal into the parallel signal, and vice versa. The SERDES 1004 can operate as a parallel-serial converting unit.

The LSI (Large Scale Integration) 1006 converts the signal format used for the optical communication line into the signal format used for the telecommunication line (e.g., the LAN (Local Area Network)), and vice versa. Moreover, the LSI 1006 detects an abnormal state of the signal such as an interruption of the signal, and issues an alarm. The LSI 1006 converts the signal format on the basis of a program stored on the ROM 1010. The ROM 1010 gets stored with the program etc employed in the LSI 1006. The RAM 1008 temporarily gets stored with data etc used on the occasion of executing the program. The RAM 1008 temporarily gets stored with the signal on the transmission side or the signal on the reception side.

The PHY 1012 is an interface related to a physical layer. The PHY 1012 takes charge of the interface between the LSI 1006 and the RJ 45 (1016). The PHY 1012 deserializes or serializes the signal on the transmission side or the signal on the reception side. That is, the PHY 1012 converts the serial signal into the parallel signal, and vice versa.

The RJ 45 (1016) is a connector for connecting a LAN cable. A terminal device (information processing device) such as a personal computer is connected via the LAN cable to the RJ 45 (1016).

The optical communication device can perform the optical communications exhibiting the stable optical output by including the optical communication module in any one of the first through eighth embodiments.

[Others]

The configurations of the respective embodiments, even other than those described above, can be properly combined and thus applied. For instance, the ferrule 606 in the sixth embodiment may also be applied as a substitute for the ferrule 806 to the eighth embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical communication module comprising:
a light emitting element to emit light;
a light transmission medium to receive incidence of the light from the light emitting element;
a diverging unit to be provided on the light transmission medium and to diverge some proportion of the light emitted from the light emitting element to the light transmission medium and propagating within the light transmission medium; and
a first light receiving element to receive the light from the light emitting element, which is diverged by the diverging unit.

2. The optical communication module according to claim 1, further comprising a control unit to control an intensity of the light emitted by the light emitting element on the basis of an intensity of the light received by the first light receiving element.

3. The optical communication module according to claim 1, wherein the light from an outside device enters the light transmission medium,
the diverging unit diverges the light entering via the light transmission medium from the outside device, and
the optical communication module further comprises a second light receiving element to receive the light entering via the light transmission medium from the outside device, which is diverged by the diverging unit.

4. The optical communication module according to claim 1, further comprising a ferrule to fix the diverging unit and the light transmission medium.

5. The optical communication module according to claim 4, wherein a material of the ferrule is transparent to a wavelength of the light.

6. The optical communication module according to claim 5, wherein the ferrule has a light shielding portion of which an end portion is roughly polished.

7. The optical communication module according to claim 5, wherein the ferrule has a light shielding portion containing a light shielding material.

8. The optical communication module according to claim 4, wherein the first light receiving element is fixed to the ferrule.

9. An optical communication device comprising:
a signal converting unit to convert a signal, for a telecommunication line, coming from an information processing device into a signal for an optical communication line;
a parallel-serial converting unit to convert the signal converted by the signal converting unit into a serial signal; and
an optical communication module to convert the serial signal into the optical signal and output the optical signal,
the optical communication module including:
a light emitting element to emit light based on the serial signal;
a light transmission medium to receive incidence of the light from the light emitting element;
a diverging unit to be provided on the light transmission medium and to diverge some proportion of the light emitted from the light emitting element to the light transmission medium and propagating within the light transmission medium;
a ferrule to fix the diverging unit and the light transmission medium;
a first light receiving element to receive the light from the light emitting element, which is diverged by the diverging unit; and
a control unit to control an intensity of the light emitted by the light emitting element on the basis of an intensity of the light received by the first light receiving element.
